(19) United States
(12) Patent Application Publication
(10) Pub. No.: US 2016/0333692 A1
(43) Pub. Date: Nov. 17, 2016

(54) VENTILATION DUCTING SYSTEMS & METHODS

(71) Applicant: Darren Gilbertson, Perth (AU)

(72) Inventor: Darren Gilbertson, Perth (AU)

(21) Appl. No.: 15/111,089

(22) PCT Filed: Jan. 12, 2015
(86) PCT No.: PCT/AU2015/050009

§ 371 Date: Jul. 12, 2016

(30) Foreign Application Priority Data
Jan. 12, 2014 (AU) 2014200172

(51) Int. Cl. E21F 1/04; F24F 13/08; F24F 13/02; E21F 1/08; F16L 55/027

(52) U.S. Cl. CPC E21F 1/04; E21F 1/08; F16L 55/027; F24F 13/0218; F24F 13/08

(57) ABSTRACT

In one preferred form of the present invention shown in FIG. 2, there is provided an airflow restriction device for mining ventilation. The airflow restriction device comprises a body having an inflatable portion. The inflatable portion is inflatable to provide a ring-type restrictor that is able to expand inwardly to reduce an inner channel area and provide a restriction to air flow

### PRIORITY

Priority is claimed from Australian Application 2014200172 entitled ‘VENTILATION DUCTING SYSTEMS & METHODS’ filed 12 Jan. 2014 in the name of the present applicant. This application is incorporated by reference for all purposes.

### FIELD OF THE INVENTION

In preferred forms, the present invention relates to ventilation ducting systems and methods for underground mining environments.

### BACKGROUND To THE INVENTION

Typically an underground mining environment will have various tunnels that extend into the earth for many kilometres.

The tunnels will often be provided with flexible ventilation ducting formed from plastics material. The flexible ventilation ducting is typically suspended from the ceiling to transport air to different areas of the mine. The ventilation ducting is typically provided in 5, 10 or 15 m sections and is of a flexible nature. Various ventilation divider devices are often used to split the flow of air between different ventilation paths.

More particularly, in order to accommodate the dynamic nature of air requirements, rope and pulley systems are sometimes used to open and close different sections of the ventilation ducting. Such rope and pulley system typically comprise a sheave block and rope with “D” shackles. By using the rope and pulleys, users can control the flow of air as required.

Problems with rope and pulley systems include: (i) the rope getting caught by machinery and being cut off; (ii) the pulleys not working and preventing the vent from being tied off; (iii) the rope not providing a full seal requiring that the secondary vent fan is turned off, if its pressure is too high. In addition, vent choke ropes and pulleys require repair and Substitute Sheet replacing. Sometimes the rope eventually tears a split in the bag which then requires a new section of ducting to be installed.

It is against this background and the problems and difficulties associated therewith that the inventor has developed the present invention.

### SUMMARY OF THE INVENTION

According to a first aspect of preferred embodiments herein described there is provided an airflow restriction device comprising: a body having an inflatable portion; the inflatable portion being able to be positioned around a length of flexible ventilation ducting; the inflatable portion being inflatable to provide a ring-type restrictor that is able to expand inwardly to reduce the cross-section of an inner channel area provided by the ring type restrictor, through which the ventilation ducting extends, to constrict the ventilation ducting.

Preferably the body includes a first end, a second end and a connection arrangement; the connection arrangement for use in selectively connecting the first end and the second end together to form the ring-type restrictor when the inflatable portion is positioned around the length of flexible ventilation ducting.

Preferably the connection arrangement includes a flap provided on the first end or the second end of the body, the flap for providing a first connection between the first end and the second end, before a second connection is provided between the first end and the second end.

Preferably the connection arrangement includes a first zipper and a second zipper for providing a releasable connection between the first end and the second end; the first zipper concealing the second zipper when in a zipped condition.

Preferably the connection arrangement includes hook or loop material to provide a hook-loop connection between the first end and the second end, before a second connection is provided between the first end and the second end.

Preferably the connection system includes anchor elements positioned on the first end and on the second end; the anchor elements for use in securing the first end and the second end together.

Preferably the anchor elements comprise a number of spaced apart loop anchors allowing connectors to secure the first end and the second end together.

Preferably the inflatable portion includes a first layer group and a second layer group; the inflatable portion being able to be inflated with air, with the air being accommodated in a region between the first layer group and the second layer group; the first layer group being relatively non-stretchable; and the second layer group being relatively stretchable, the first and the second layer groups serving to assist the ring-type restrictor to expand inwardly to reduce the inner channel area and provide the restriction to air flow.

Preferably the first layer group comprises a first layer and a second layer, the first layer being relatively non-stretchable and the second layer being relatively stretchable; the first layer serving to make the first layer group relatively non-stretchable, and the second layer providing a relatively air impermeable layer in comparison to the first layer.

Preferably the second layer group comprises a relatively stretchable layer, the relatively stretchable layer being relatively air impermeable.

Preferably the body includes a hanging connector for use in supporting the body above the ground, with the body and the inflatable portion being positioned around the length of the flexible ventilation ducting, the hanging connector extending along the length of the ventilation ducting.

Preferably the hanging connector comprises a flap of material having eyelets therein.

Preferably the airflow restriction device includes a drain for condensation, the drain providing a seal when there is sufficient pressure applied to the drain, and otherwise providing an open drainage outlet through which water is able to pass.

Preferably the hanging connector comprises a hanging fin; an air fitting is fixed to the hanging fin; and a conduit extends from the air fitting to an inlet extending into the inflatable potion; the air fitting assisting with protecting the inflatable portion from the inlet.

Preferably the inflatable portion has a width of at least 0.8 m, the width extending along the ventilation ducting, when the inflatable portion is positioned around the ventilation ducting.

Preferably the inflatable portion has a width of at least 1 m, the width extending along the ventilation ducting, when the inflatable portion is positioned around the ventilation ducting.

Preferably the inflatable portion has a length of at least 3 m, the length extending around the ventilation ducting, when the inflatable portion is positioned around the ventilation ducting.

Preferably the inflatable portion has a length of at least 3.8 m, the length extending around the ventilation ducting, when the inflatable portion is positioned around the ventilation ducting.

Preferably the restriction device can be rolled and stored in a 300 mm diameter cylindrical tube.

Preferably the inflatable portion has a diameter of at least 1 m, when the inflatable portion is positioned around the ventilation ducting.

According to a second aspect of preferred embodiments herein described there is provided an airflow restriction device comprising: a body providing a length of ventilation ducting; an inflatable portion; the inflatable portion being inflatable to provide a ring-type restrictor that is able to expand inwardly to reduce the cross-section of an inner channel area provided by the ring type restrictor and provide a restriction to air flow.

Preferably the inflatable portion is an integral component of the airflow restriction device.

Preferably the airflow restriction device includes a restriction improver that is positioned to be constricted by the inflatable portion, when the inflatable portion is inflated, to restrict air flow through the restriction improver.

Preferably the restriction improver is positioned to lie within a passage provide by the inflatable portion.

Preferably the restriction improver comprises a sock-type element fixed to the body at a first position and having a free end spaced therefrom.

Preferably the sock-type element extends from the position at which the element is fixed to the body through the inner channel area, to provide the free end in a position spaced away from the inflatable portion.

Preferably the inflatable portion is located between a first end and a second end of the body providing the length of ventilation ducting; each of the first end and the second end providing a ventilation ducting sleeve having a connector for connecting the body to respective ventilation ducting.

Preferably the inflatable portion includes a first layer group and a second layer group; the inflatable portion being able to be inflated with air, with the air being accommodated in a region between the first layer group and the second layer group; the first layer group being relatively non-stretchable; and the second layer group being relatively stretchable, the first and the second layer groups serving to assist the ring-type restrictor to expand inwardly to reduce the inner channel area and provide the restriction to air flow.

Preferably the first layer group comprises a first layer and a second layer, the first layer being relatively non-stretchable and the second layer being relatively stretchable; the first layer serving to make the first layer group relatively non-stretchable, and the second layer providing a relatively air impermeable layer in comparison to the first layer.

Preferably the second layer group comprises relatively stretchable layer to assist with providing the restriction to air flow, the relatively stretchable layer being relatively air impermeable.

Preferably the airflow restriction device includes a drain for condensation, the drain providing a seal when there is sufficient pressure applied to the drain, and otherwise providing an open drainage outlet through which water is able to pass.

Preferably body provides a length of ventilation ducting at least 5 m long.

Preferably the inflatable portion has a width, along the longitudinal direction of the body, about 1 m long.

According to a third aspect of preferred embodiments herein described there is provided a method of manufacturing an airflow restriction device comprising: providing a length of material as a first layer; the length having a first end and a second end; positioning a second layer of material across the length between the first end and the second end; the second layer being narrower in the direction of the length the first layer; and joining the sides extending in the direction of the length to form a section of ventilation ducting; the first layer and second layers forming part of the ring type restrictor.

Preferably the first layer is relatively non-stretchable and the second layer is relatively stretchable.

Preferably the method includes positioning an intermediate layer between the first layer and the second layer; the second layer and the intermediate layer providing a bladder and being relatively air impermeable in comparison to the first layer.

Preferably the first layer is relatively non stretchable and the second and third layers are relatively stretchable to assist with providing the restriction to air flow.

According to a fourth aspect of preferred embodiments herein described there is provided a method of manufacturing an airflow restriction device, comprising providing a body having inflatable portion that is inflatable to provide a ring-type restrictor that expands inwardly to reduce an inner channel area and provide a restriction to air flow; the method including providing the body with a first sleeve to allow air to flow into the channel area of the inflatable portion; and a second sleeve to allow air to flow out of the channel area of the inflatable portion.

Preferably the method includes providing the first sleeve and the second sleeve with a connector arrangement to connect to respective ventilation ducting.

According to a fifth aspect of preferred embodiments herein described there is provided a method of manufacturing an airflow restriction device, the method comprising:
forming a body by fixing together a number of layers of material to provide an inflatable portion having an inflatable chamber between a first layer group and a second layer group; the first layer group being relatively non-stretchable; and the second layer group being relatively stretchable; and
providing the first layer group with a connector allowing the inflatable portion to provide an inflatable ring type restrictor; the first and second layer groups serving to assist with the ring-type restrictor being able to expand inwardly to reduce an inner channel area and provide a restriction to air flow.

Preferably the method includes fixing a flap to a first end of the outer surface of the first layer group, to allow the body to be positioned around a length of flexible ventilation ducting and to be joined with the assistance of the flap.

Preferably the method includes fixing a flap to a second end of the outer surface of the first layer group, to allow the body to be positioned around a length of flexible ventilation ducting and to be joined with the assistance of the flap.

Preferably the method includes fixing a hanging connector to the first layer group, the hanging connector for use in supporting the body above the ground.

According to a sixth aspect of preferred embodiments herein described there is provided an airflow restriction device comprising: a body having an inflatable portion; the inflatable portion being inflatable to provide a ring-type restrictor that is able to expand inwardly to reduce the inner channel area provided by the ring type restrictor and provide a restriction to air flow.

Preferably the body is provided as a length of ventilation ducting with the inflatable portion being an integral component thereof.

Preferably the airflow restriction device includes a restriction improver that is positioned to be constricted by the inflatable portion, when the inflatable portion is inflated, to restrict air flow through the inner channel area.

Preferably the restriction improver comprises a sock-type element fixed to the body at a first position and having a free end spaced away from the inflatable portion.

Preferably the sock-type element is of a length to through the ring-type restrictor provided by the inflatable portion, to provide the free end in a position spaced away from the inflatable portion.

Preferably the body includes a first end and a second end; the first end and the second end allowing the body to be positioned around a length of flexible ventilation ducting; the body including a connection arrangement for use in connecting the first end and the second end together when the body is positioned around the length of ventilation ducting.

Preferably the inflatable body is formed using stitching that acts as a form of pressure release to assist with preventing over inflation of the inflatable portion.

Preferably the inflatable portion includes a first layer group and a second layer group; the inflatable portion being able to be inflated with air, with the air being accommodated in a region between the first layer group and the second layer group; the first layer group being relatively non-stretchable; and the second layer group being relatively stretchable, the first and the second layer groups serving to assist the ring-type restrictor to expand inwardly to reduce the inner channel area and provide the restriction to air flow.

Preferably the first layer group comprises a first layer and a second layer, the first layer being relatively non-stretchable and the second layer being relatively stretchable; the first layer serving to make the first layer group relatively non-stretchable, and the second layer providing a relatively air impermeable layer in comparison to the first layer.

Preferably the second layer group comprises relatively stretchable layer, the relatively stretchable layer being relatively air impermeable.

Preferably the inflatable portion is able to be expanded from a thin-walled cylinder-type annular form to a relatively expanded-type annular form.

Preferably the body is able to be stored in a relatively flat configuration; and then be positioned to provide a ring-type restrictor that is able to reduce the inner channel area to provide a restriction to air flow.

Preferably body has a diameter between 1050 to 1400 mm when the inflatable portion is inflated to provide a restriction to air flow.

According to a seventh aspect of preferred embodiments herein described there is provided an airflow restriction device for a length of flexible mining ventilation ducting comprising: a body having an inflatable portion; the inflatable portion being able to be positioned around the length of mining flexible ventilation ducting; the inflatable portion being inflatable to provide a ring-type restrictor that is able to expand inwardly to reduce an inner channel area provided by the ring type restrictor, through which the ventilation ducting extends, to constrict the ventilation ducting.

According to an eighth aspect of preferred embodiments herein described there is provided a length of mining ventilation ducting having an inbuilt inflatable portion; the inflatable portion being inflatable to provide a ring-type restrictor that is able to expand inwardly to reduce an inner channel area provided by the ring-type restrictor and provide a restriction to air flow.

According to a ninth aspect of preferred embodiments herein described there is provided a mining ventilation restrictor comprising a ring-type restrictor that is able to be inflated to expand inwardly to provide a restriction to air flow; the ring-type restrictor forming part of a section of ventilation ducting or able to fit over a section of ventilation ducting.

According to a tenth aspect of preferred embodiments herein described there is provided a method of manufacturing a mining ventilation restrictor: comprising layering two sheets across a length of a first sheet; joining the two sheets to the first sheet; and as part of the method forming a ventilation duct with a ring type restrictor therein.

In preferred embodiments herein described, there may be advantageously provided:
1) Ventilation restriction devices that are able to be fitted around flexible ventilation ducting in a mining environment.
2) Ventilation restriction devices that have an inflatable portion that is able to expand radially inwardly to form an expanding ring-type restrictor that annularly constricts the ventilation ducting.
3) Ventilation restriction devices provided as an integral length of ventilation ducting and which have an inflatable portion that is able to expand radially inwardly to form an expanding ring-type restrictor that provides a restriction to air flow.
4) Ventilation restriction devices provided as an integral length of ventilation ducting and which have an airflow restriction improver, the inflatable portion being able to expand radially inwardly to form an expanding ring-type restrictor that annularly constricts the air flow restriction improver.
5) Ventilation restriction devices manufactured by layering and joining a number of sheets to provide a ring-type restrictor.

It is to be recognised that other aspects, preferred forms and advantages of the present invention will be apparent from the present specification including the detailed description, drawings and claims.

### BRIEF DESCRIPTION OF DRAWINGS

In order to facilitate a better understanding of the present invention, several preferred embodiments will now be described with reference to the accompanying drawings as detailed below.

FIG. 1 provides a perspective schematic view of conventional ventilation ducting as used in a mining environment.

FIG. 2 provides a side view of a ventilation restriction device according to a first preferred embodiment of the present invention, the device being fitted to the ventilation ducting shown in FIG. 1.

FIG. 3 provides a schematic side view of the ventilation restriction device in an expanded state.

FIG. 4 provides a schematic sectional view of the ventilation restriction device in an expanded state.

FIG. 5 provides a schematic front view of the ventilation restriction device in an expanded state.

FIG. 6 provides a schematic sectional view of the ventilation restriction device wrapped around the ventilation ducting to restrict the flow of air.

FIG. 7 provides a schematic sectional view of the ventilation restriction device wrapped around the ventilation ducting.

FIG. 8 provides an enlarged schematic sectional view of the ventilation restriction device wrapped around the ventilation ducting.

FIG. 9 provides an enlarged schematic sectional view of the ventilation restriction device in an expanded state.

FIG. 10 provides a schematic sectional view of the ventilation restriction device in an expanded state.

FIG. 11 provides a side schematic view of the ventilation restriction device.

FIG. 12 provides an exploded side schematic view of the ventilation restriction device.

FIG. 13 provides a schematic sectional view of the ventilation restriction device wrapped around the ventilation ducting to restrict the flow of air.

FIG. 14 provides a side schematic view of the ventilation restriction device.

FIG. 15 provides a top schematic view of the ventilation restriction device.

FIG. 16 provides a perspective schematic view of a ventilation restriction device according to another preferred embodiment of the present invention.

FIG. 17 provides a perspective schematic view of a ventilation restriction device according to another preferred embodiment of the present invention.

FIG. 18 provides a cross-sectional view of the ventilation restriction device shown in FIG. 17.

FIG. 19 provides an illustrative sectional view of a ventilation restriction device shown in FIG. 17.

FIG. 20 provides a block diagram of a method of manufacture according to another preferred embodiment of the present invention.

FIG. 21 provides a block diagram of the method shown in FIG. 20.

FIG. 22 provides a side schematic view of a ventilation restriction device according to another preferred embodiment of the present invention.

FIG. 23 provides a schematic view of an inlet used in the ventilation restriction device shown in FIG. 22.

FIG. 24 provides a further illustrative view of the inlet shown in FIG. 23.

FIG. 25 provides a schematic cross-sectional view of the ventilation restriction device show in in FIG. 22.

FIG. 26 provides a schematic cross-sectional view of the ventilation restriction device shown in FIG. 22, the device being wrapped around ventilation ducting.

FIGS. 27 to 29 provides a view of the ventilation restriction device shown in FIG. 22, the device in operation.

FIG. 30 provides a schematic view of a ventilation restriction device according to another preferred embodiment of the present invention.

FIG. 31 provides a side schematic view of a further ventilation restriction device according to another preferred embedment of the present invention.

FIG. 32 provides a view of a ventilation restriction device according to another preferred embodiment of the present invention;

FIGS. 33 and 34 provide side schematic views of the ventilation restriction device shown in FIG. 32;

FIG. 35 provides a side schematic view of the restriction device shown in FIG. 32 when positioned around a ventilation tube.

FIGS. 36 to 39 provide a number of views of a further preferred embodiment of the present invention.

### DETAILED DESCRIPTION OF THE EMBODIMENTS

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

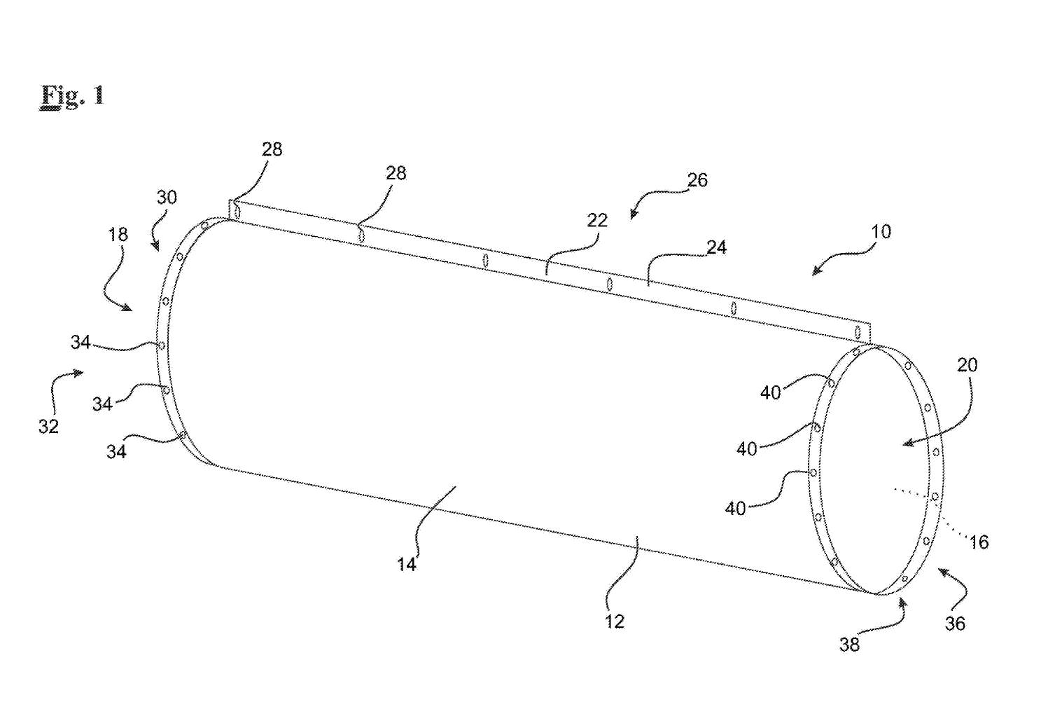

Referring to FIG. 1 there is shown a conventional section ventilation ducting 10 for a mining environment. The ventilation ducting 10 comprises a section 12 about 5 m in length and about 1 m in diameter. Ventilation ducting of this form is known to come in lengths of 5 m, 10 m, 15 m, 20 m and more.

The ventilation ducting 12 is flexible and has a tubular body 14. The ventilation ducting is formed for polyethylene plastics material. The tubular body 14 provides a passage 16. The passage 16 extends between a first end 18 and a second end 20 of the body 14. Air is able to be pumped (fanned or otherwise) into the first end 16, travel through the passage 16 and out the second end 20.

A hanging fin 22 extends between the first end 18 and the second end 20. The hanging fin 22 is provided in the form of a flap 24 extending upwardly from the tubular body 14. The hanging fin 24 includes a connector 26 in the form of a number of openings 28 extending along the hanging fin 22 for use in attaching rope. The openings 28 are spaced about 1 m apart.

The first end 18 provides an inlet 30 having a connector 32 extending around the rim of the inlet 30. The connector 32 is provided in the form of a number of openings 34. The second end 20 provides an outlet 36 having a connector 38 extending around the rim of the outlet 36. The connector 32 is provided in the form of a number of openings 40.

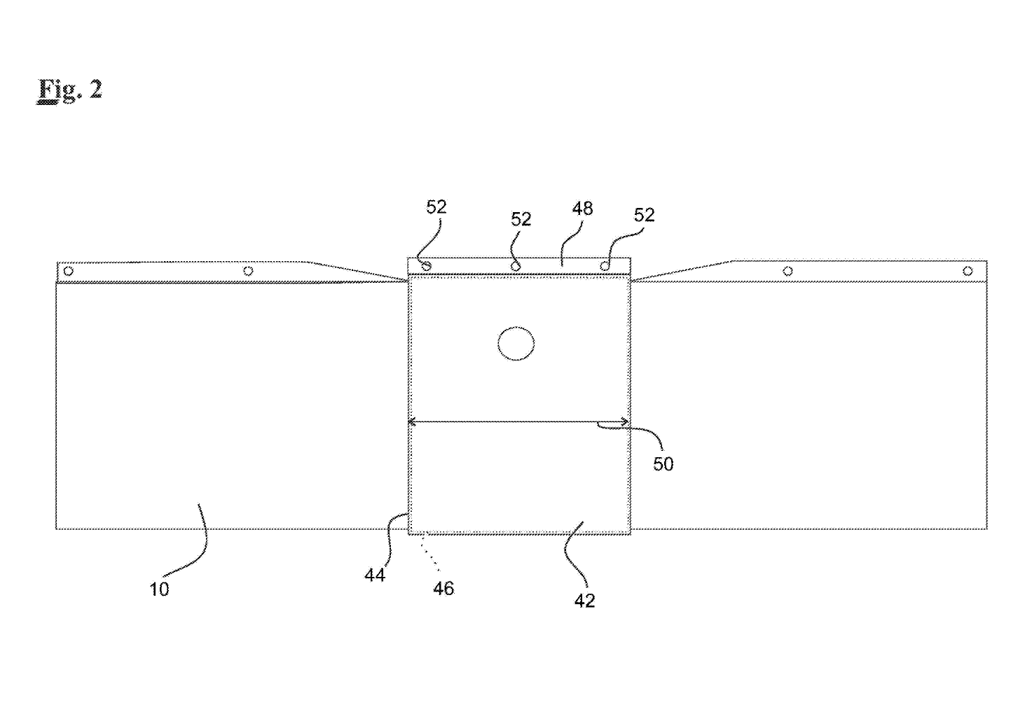

Referring to FIG. 2 there is shown an airflow restriction device 42 according to a first preferred embodiment of the present invention. The airflow restriction device 42 is able to advantageously restrict the flow of air through the conventional mining ventilation ducting 10 shown in FIG. 1.

The airflow restriction device 42 comprises a body 44 having an inflatable portion 46. A hanging connector 48 is provided to allow the air flow restriction device 42 to be supported above the ground when wrapped around the ventilation ducting 10. As shown the hanging connector 48 comprises a width 50 that, with the body 44 in position around the section 12, extends in the direction of the length of the ventilation ducting 10. The hanging connector 48 includes a number of hanging openings 52.

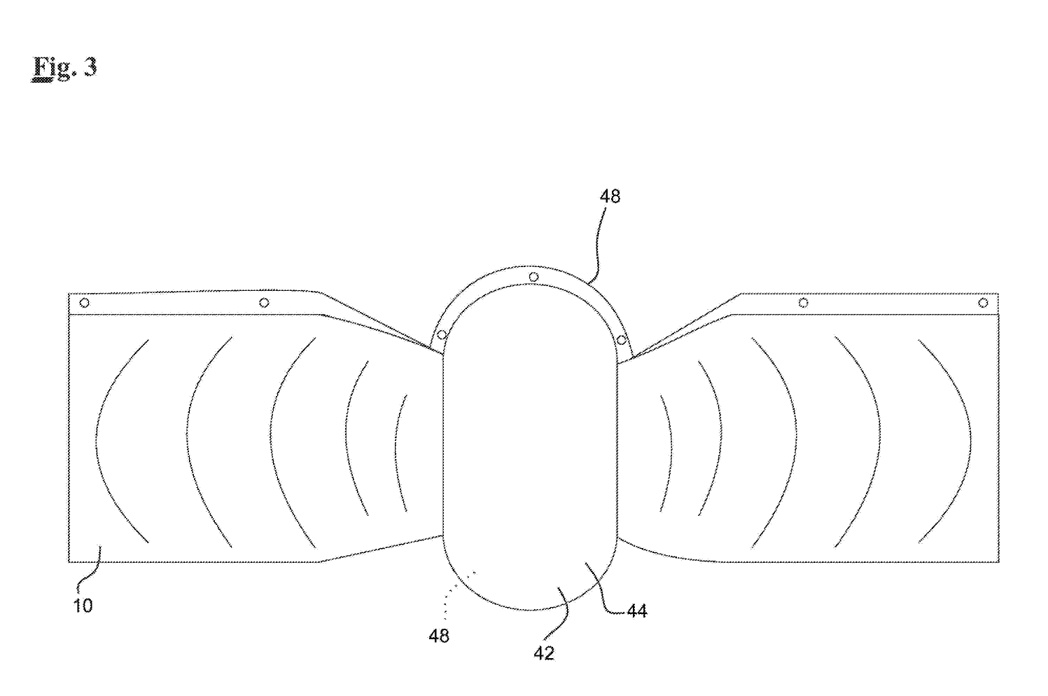

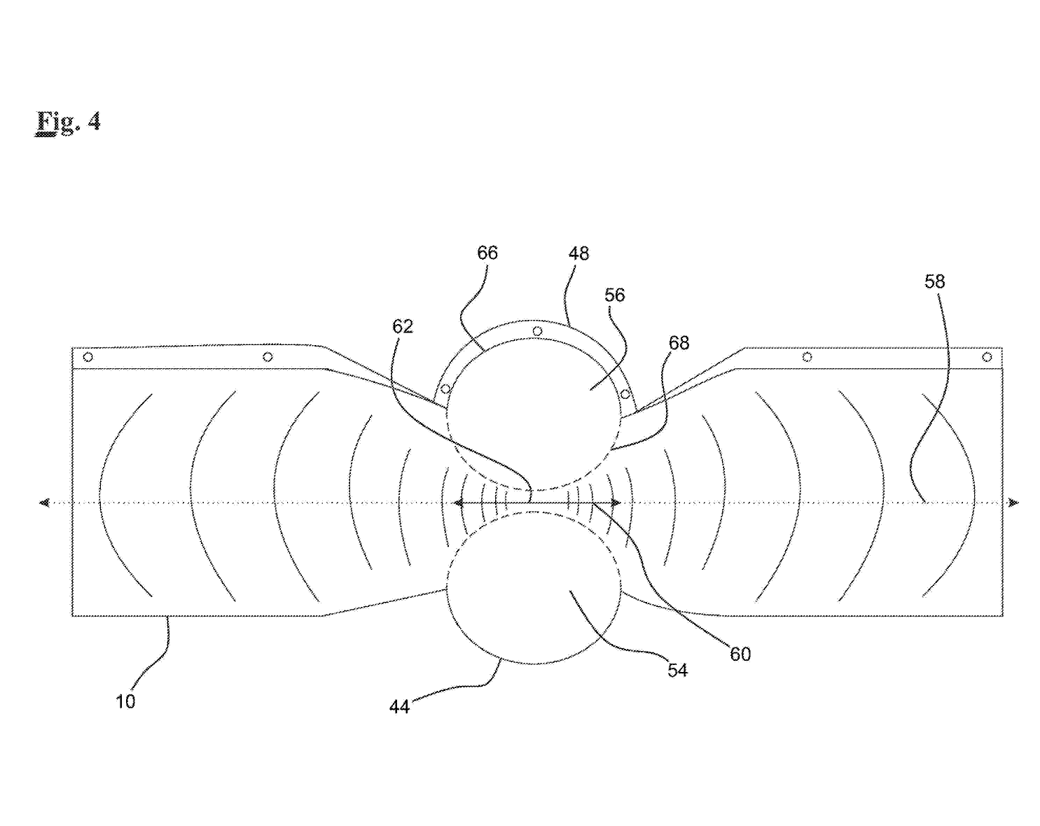

The body 44 and the inflatable portion 46 are able to be positioned around the ventilation ducting 10. When so positioned, the inflatable portion 46 is inflatable to provide a ring-type restrictor 54 that is able to expand as illustrated in FIGS. 3 and 4. Notably, FIGS. 3 to 6 are illustrative. In a working system, the hanging fin 22 stays relatively straight as it is fixed to heavy cable (Nokka line) via safety clips through the ringed eyelets. The heavy cable applies tension to the hanging fin 22.

FIG. 4 provides a schematic sectional view of the ventilation restriction device 44 in an expanded state. The ring type restrictor 54 has a rounded cross-section 56 that forms an annular ring around the ventilation ducting 10.

As would be apparent a 360 degree-type cross-section 56 is rotated about a central axis 58 to provide the ring-type restrictor 54. The ring type restrictor 54 provides an inner channel 60 bounded by the restrictor 54. The inner channel is centrally positioned narrows to provide a neck portion 62 through with the body 14 of the ventilation ducting 10 is forced to extend through. A gradual narrowing of the cross-section of the channel 60 is shown in FIG. 4.

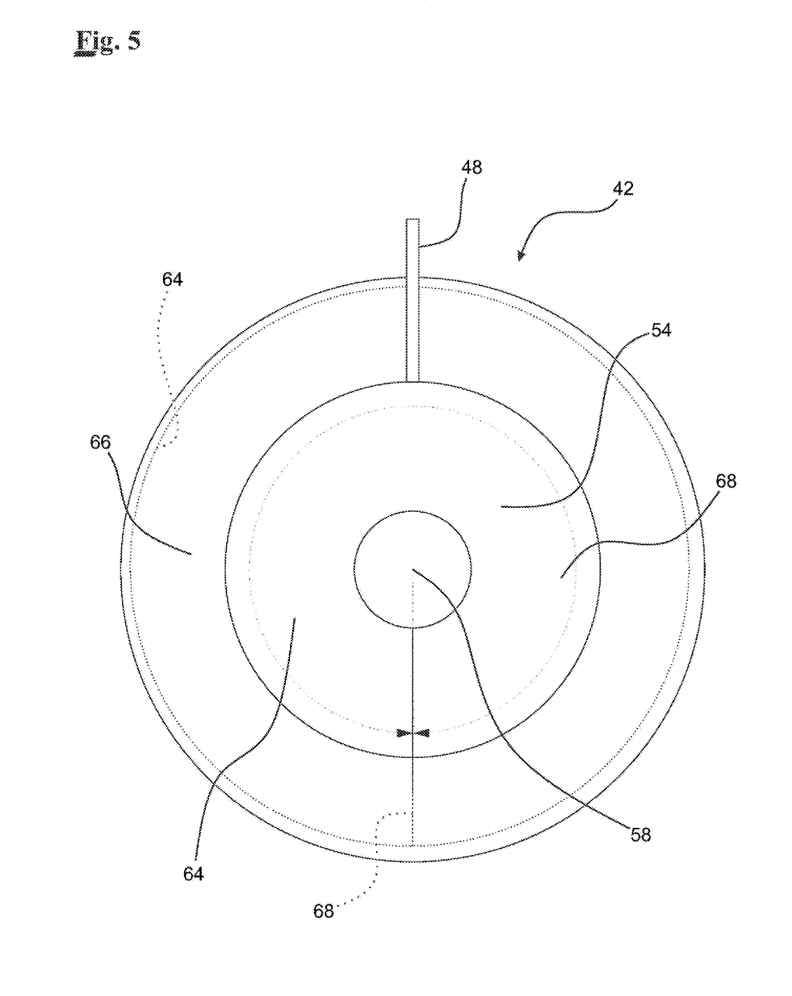

FIG. 5 provides a schematic front view of the ventilation restriction device 42 in an expanded state. As shown, the ring-type restrictor 54 is substantially continuous in the sense of the inflatable portion 64 providing a near to full 360 degree compression to the ventilation ducting 10 (the ventilation ducting 10 is not shown in FIG. 5). The device 42 includes an outer layer 66 and a bladder 68

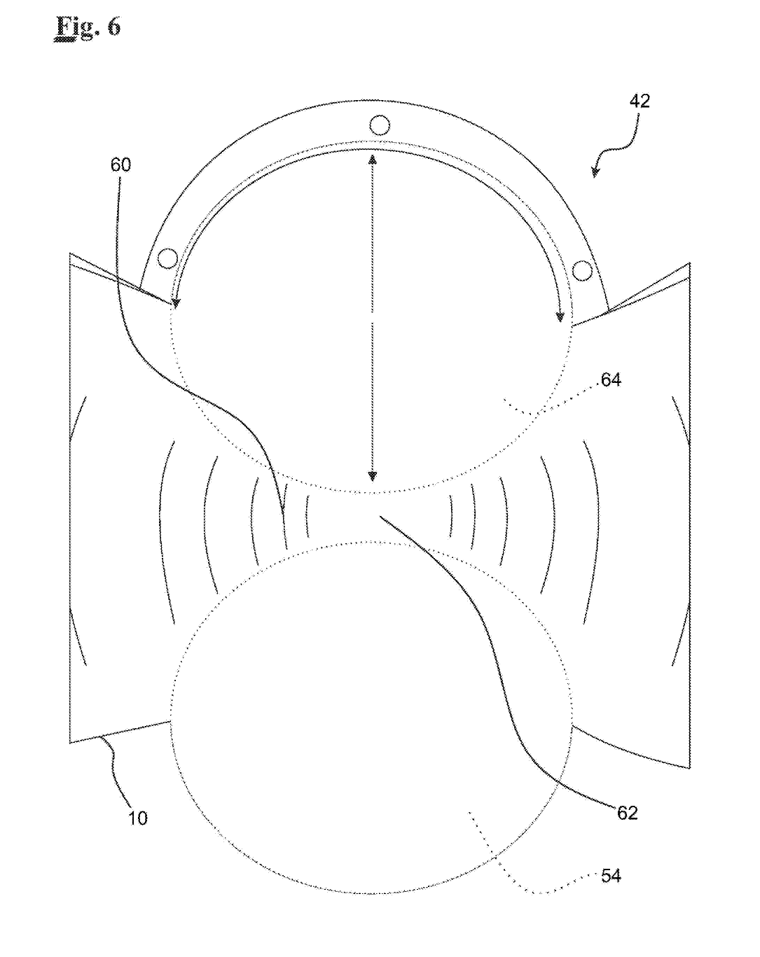

FIG. 6 highlights the inflatable portion 64 being able to expand inwardly to reduce the cross-section of the central channel 60 provided by the ring type restrictor 54, through which the ventilation ducting 10 extends, to constrict the ventilation ducting 10. The inflatable portion 64 is able to constrict the ventilation ducting 10 into a relatively small passage at the neck portion 62. This provides an advantageous restriction to the airflow.

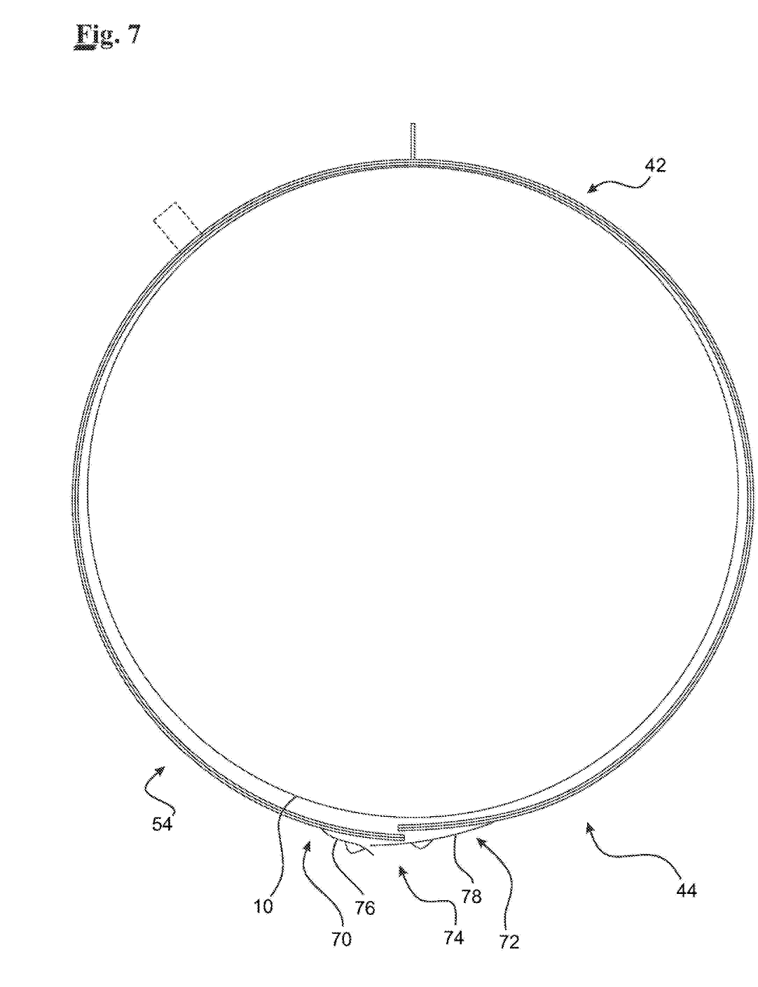

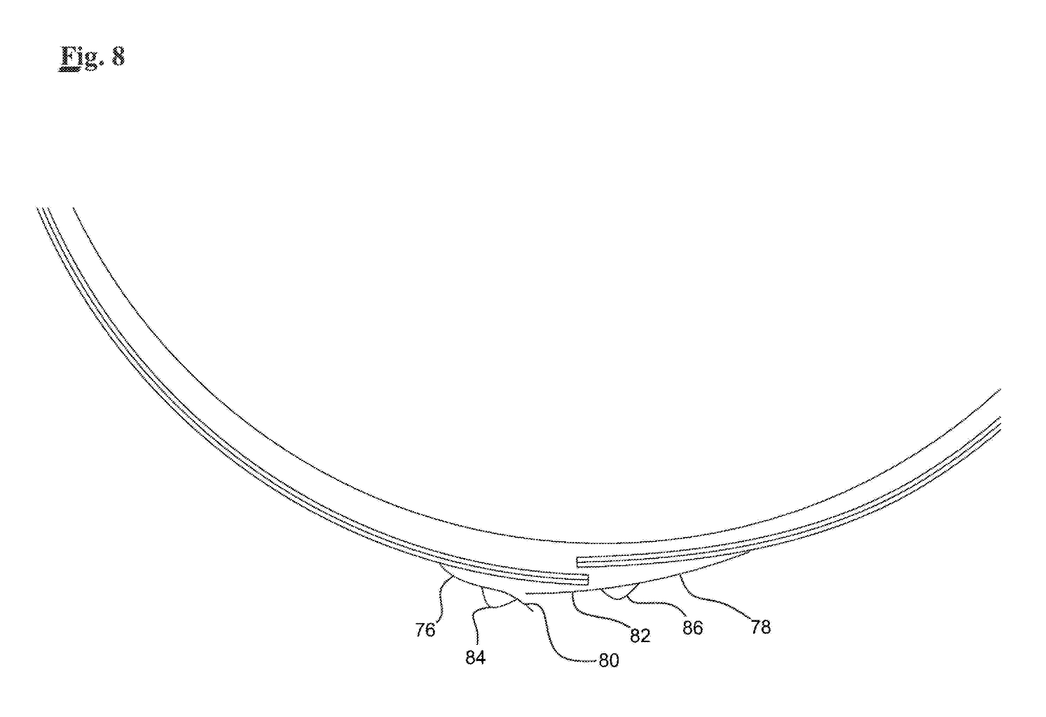

FIG. 7 provides schematic front sectional view of the ventilation restriction device wrapped around the ventilation ducting 10. As shown the body 44 includes a first end 70 and a second end 72. The first end 70 and the second end 72 provide connection ends that are able to be releasably joined together.

A connection arrangement 74 is provided between the first end 70 and the second end 72. The connection arrangement 72 is able to be used to selectively connect the first end 70 and the second end 72 together, to form the ring-type restrictor 54 when the inflatable portion is positioned around the length of flexible ventilation ducting 10 as shown. Various forms of connection arrangement 72 could of course be provided. In the present embodiment there are provide a first flap portion 76 and a second flap portion 78.

The first flap portion 76 and the second flap portion 78 include VELCRO™ material for providing a first connection between the first end 76 and the second end 78, before a second secure connection is provided between the first end 76 and the second end 78. In the present embodiment hook or loop material is provided on the inner surface 80 of the first flap portion 76. Corresponding hook or loop material is provided on the outer surface 82 of the second flap portion 78. A connector arrangement 84 is provided on the first flap portion 76 and a connector arrangement 86 is provided on the second flap portion 78. The connector arrangements 84, 86 are each provided as a series of loop anchor elements for corresponding carabineers (not shown). Various forms of connection arrangement 74 are of course possible including, for example, zip or clip type connector arrangements.

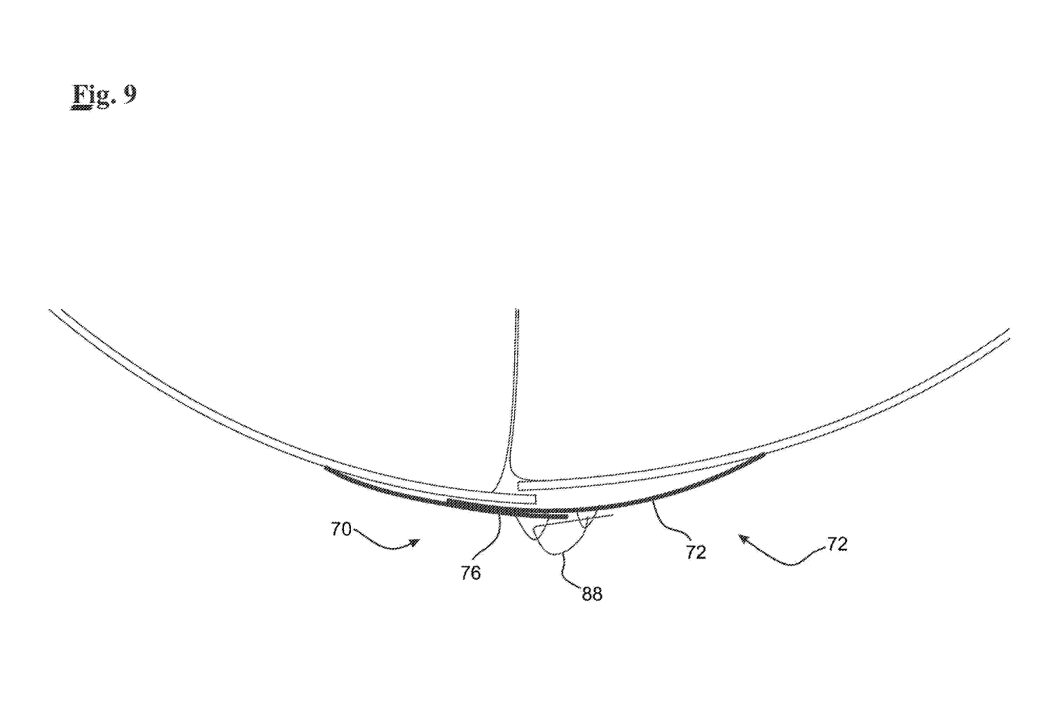

The VELCRO™ material provides an initial connection between the first end 70 and the second end 72, before the carabineers are applied. FIGS. 9 and 10 illustrate the use of a carabineer 88. FIG. 10 additionally shows the gradual reduction of the ventilation ducting 10 to fit through the neck portion 62. In the present embodiment three loop anchors are provided on each of the first end 70 and the second end 72.

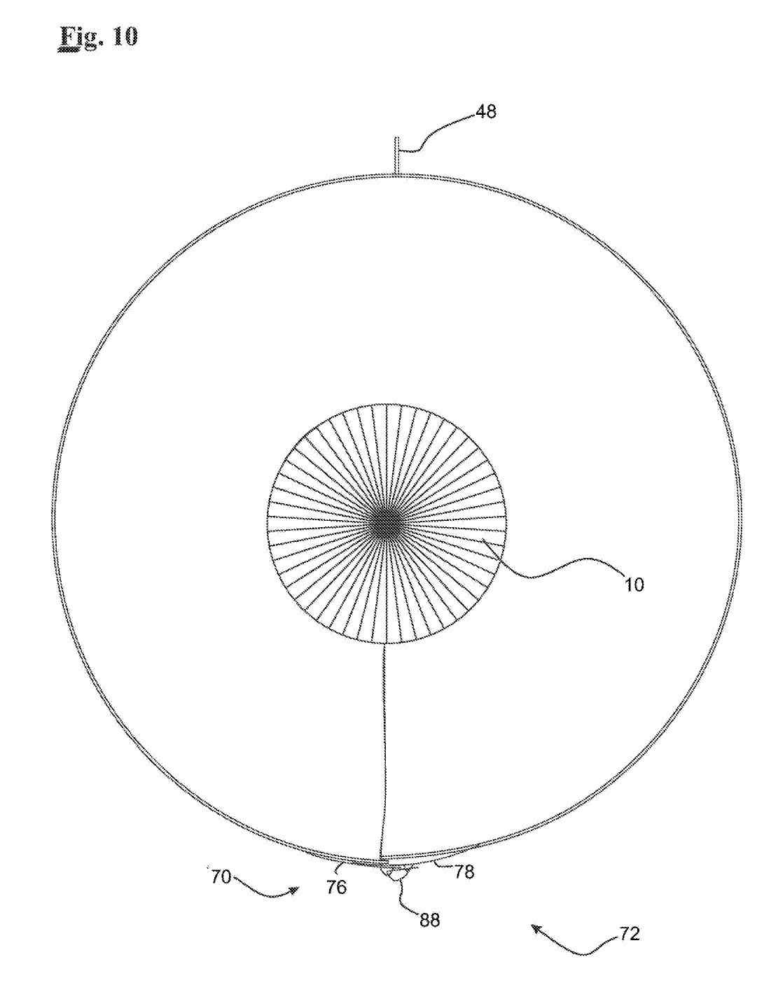

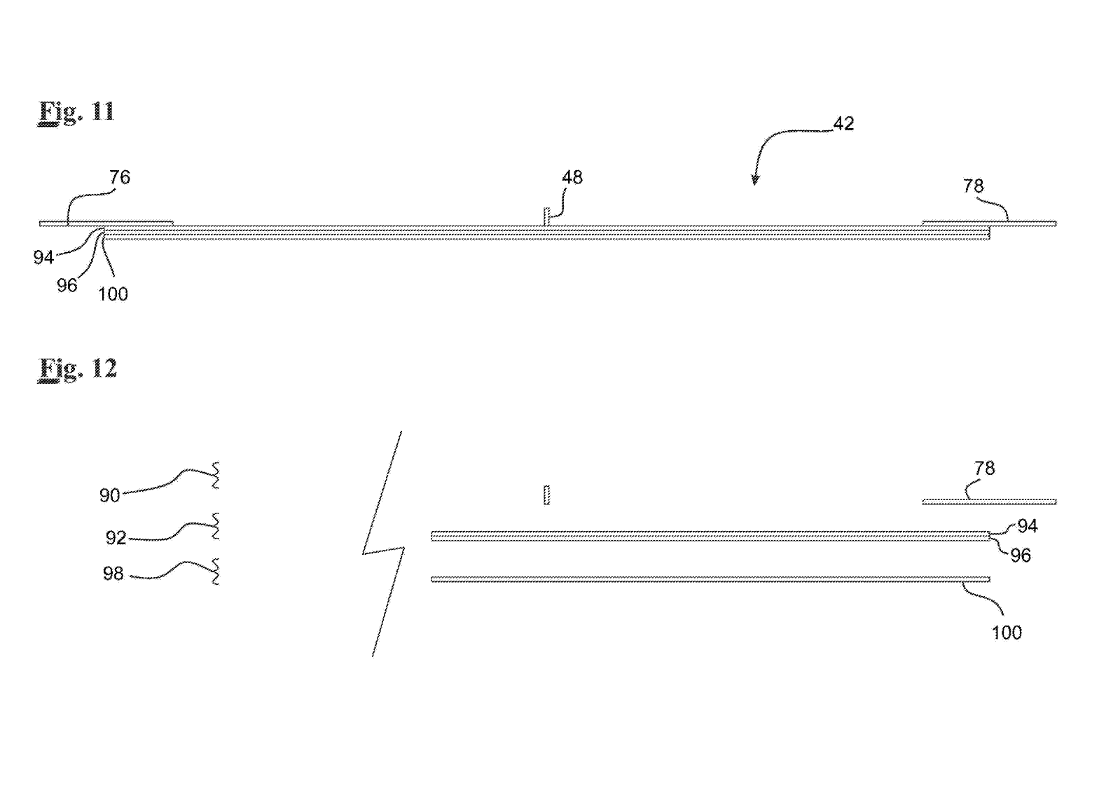

FIG. 11 provides a side schematic view of the airflow restriction device 42 illustrating the construction of the airflow restriction device 42.

FIG. 12 provides an exploded partial view. A top layer group 90 is provided by the first flap portion 76 and the second flap portion 78. A second layer group 92 is provided by a first layer 94 which is positioned on top of a second layer 96. A third layer group 98 is provided by a third layer 100.

The inflatable portion 64 includes a bladder that is formed by the second layer 96 and the third layer 100. The inflatable portion 64, which could be considered to be the air restriction device 42 as a whole, includes the first layer 94. The first layer 94 does not in itself directly contact the air that is used to inflate the inflatable portion 64 but rather provides a layer that is relatively non-stretchable in comparison to the second layer 96 and the third layer 100. The second layer 96 and the third layer 100 are relatively air impermeable to provide the bladder. The first layer 94 is provided in a much more permeable form, namely woven polyethylene, while the second layer 96 and the third layer 100 are formed from flexible PVC (polyvinyl chloride) material. The second layer 96 and the third layer 100 are heat sealed to provide a bladder that is then stitched to the first layer 94.

This the inflatable portion 64 includes a first layer group 92 and a second layer group 98. The inflatable portion 64 is able to be inflated with compressed air, with the air being accommodated in a region between the first layer group 92 and the second layer group 98. The first layer group 92 is relatively non-stretchable due to the presence of the first layer 94 and second layer group 98 is relatively stretchable. The form of the first layer group 92 and the second layer groups 100 advantageously serves to assist the ring-type restrictor 54 to expand inwardly to reduce the central channel area 60 and provide the restriction to air flow.

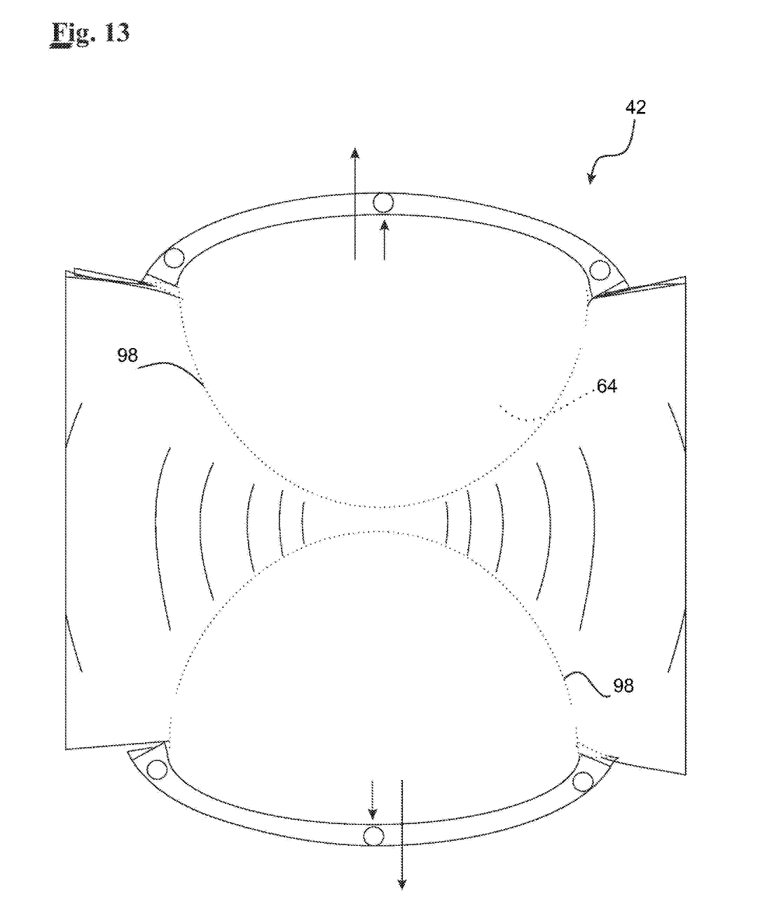

FIG. 13 illustrates how the relatively stretchable third layer group 98 stretches preferentially to the second layer group 92. The arrangement is considered to advantageously assist with directing the expansion of the inflatable portion 64 inwardly as shown. As before, the provision of cable holding the ventilation restriction device 54, also serves to straighten the hanging fin.

Thus the arrangement provides a first layer group 92 that comprises the first layer 94 and a second layer 96. The first layer 94 being relatively non-stretchable and the second layer 96 being relatively stretchable, The first layer serves to make the first layer group 92 relatively non-stretchable, and the second layer 96 provides a relatively air impermeable layer in comparison to the first layer. The third layer group 98 comprises a relatively stretchable layer, the relatively stretchable layer being relatively air impermeable.

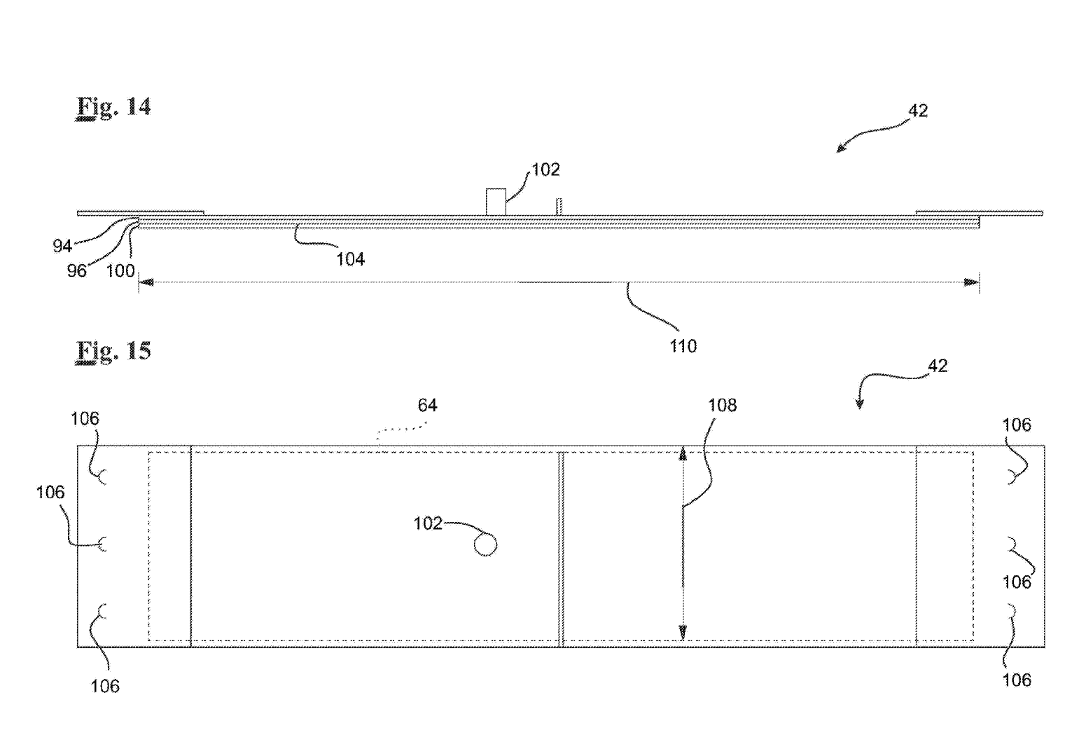

FIG. 14 illustrates an inlet 102 that extends through the first layer 94 and the second layer 96 to facilitate the passage of air into and out of the bladder in the region 104 between the second layer 96 and the third layer 100. A series of connector elements 106 are provided on each of the first end 70 and the second end 72 as shown.

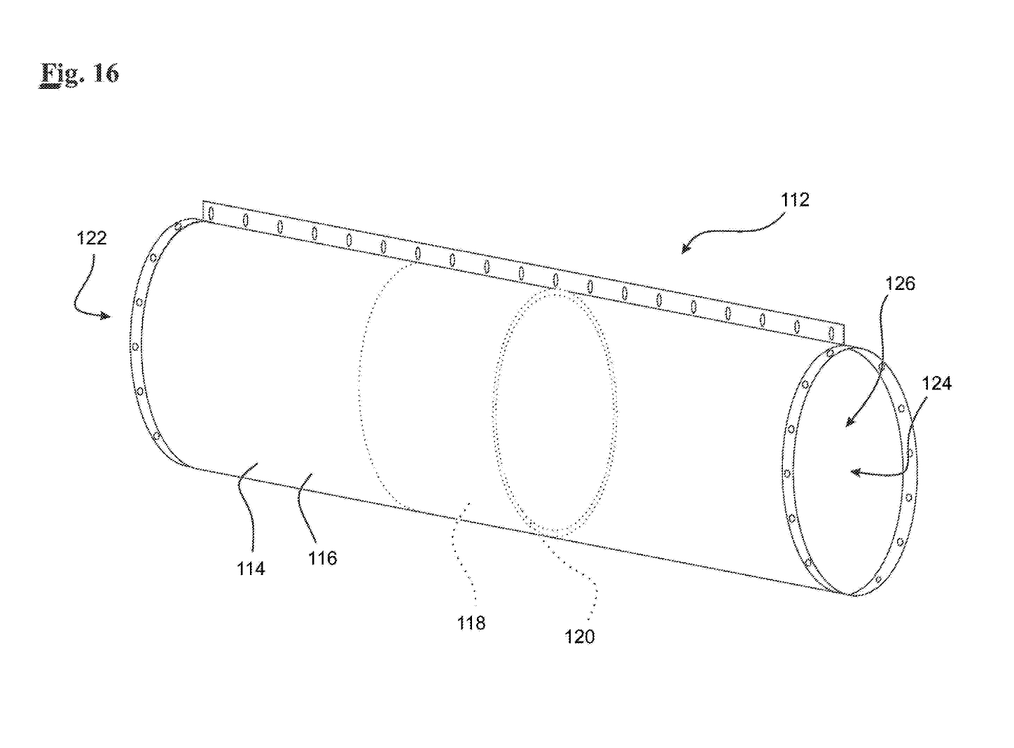

Referring to FIGS. 14 and 15, the inflatable portion is of a width 108 of about 1 m and a length 110 of about 4 m (or more precisely in this case 3.8 m). As would be apparent the width 108 extends along the ventilation ducting 10 when the inflatable portion is positioned around the ventilation ducting 10. The length 110 extends around the ventilation ducting 10.

The air restriction device 42 is of an advantageously flat configuration. The body of the air restriction device is formed from sheets of material. The flat and flexible configuration of the restriction device 42, in this embodiment, advantageously allows the device to be rolled in the direction of length 110 and be stored in a 300 mm diameter cylindrical tube.

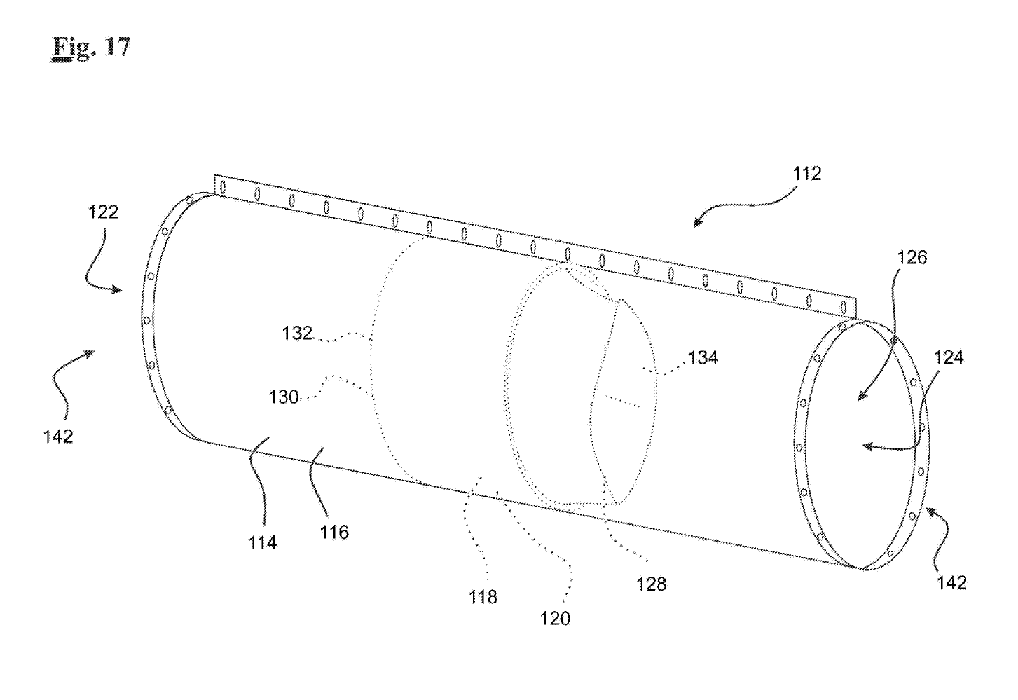

Referring to FIG. 16 there is shown an airflow restriction device 112 according to another preferred embodiment of the present invention. The airflow restriction device 112 advantageously comprises a body 114 providing a length of ventilation ducting 116. The device includes an inflatable portion 118 that is inflatable to provide a ring-type restrictor 120 that is able to expand inwardly to reduce a central channel area provided by the ring type restrictor 120 and provide a restriction to air flow. The inflatable portion 118 is provided as an integral component of the airflow restriction device 112 in the sense of not being separable therefrom. The airflow restriction device 112 includes a first end 122 and a second end 124. The ends 122, 124 provide openings for the passage of air though the passage 126 provided by the body 114.

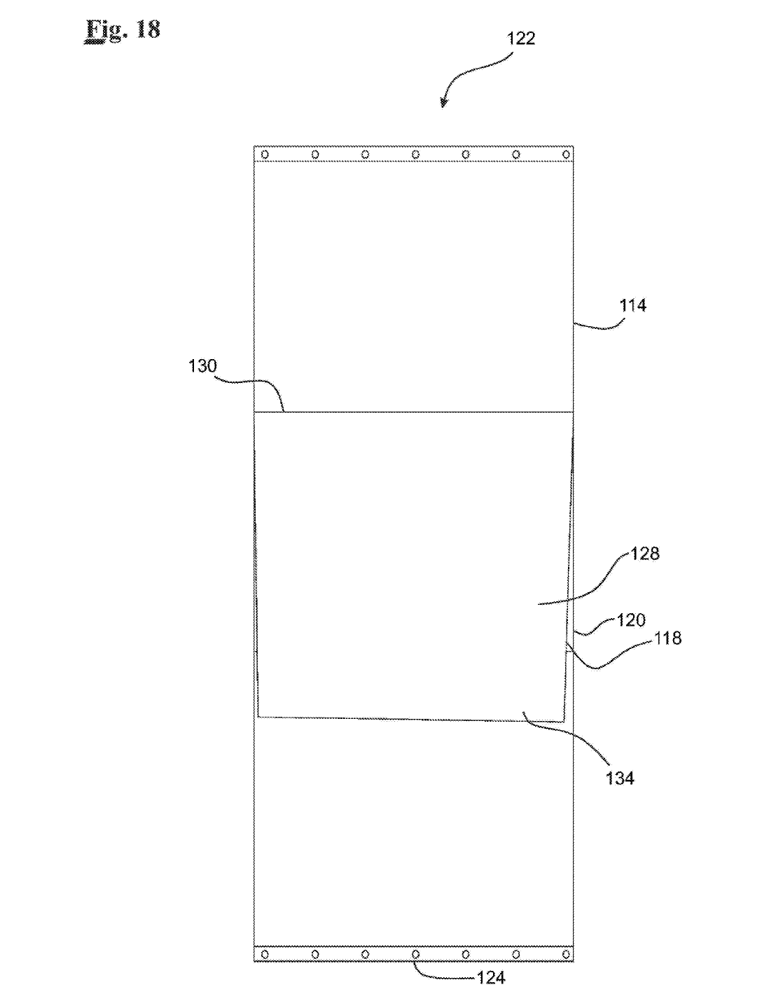

Referring to FIG. 17, the airflow restriction device 112 includes a restriction improver 128 that is positioned to lie within the inflatable portion 118 between the first end 122 and the second end 124. The restriction improver 128 is positioned to be constricted by the inflatable portion 1120 when the inflatable portion 118 is inflated, to restrict air flow through the restriction improver 128 and the device 112. As shown in FIG. 17, the restriction improver 128 is provided in a tubular form.

The restriction improver 128 provides the function of occupying a central channel provided by the ring-type restrictor 120 to provide an increased restriction to airflow. This is considered to advantageously assist with limiting airflow.

FIG. 18 provides a cross-sectional view showing the restriction improver 128, the inflatable portion 118, and the body 114. The restriction improves is circumferentially fixed at the join between the inflatable portion 118 and the remainder of the body 114 as represented by line 130. The restriction improver 128 has a fixed end 132 and a free end 134. The restriction improver 128 provides a sock-type element fixed to the body at a first position and having a free end spaced therefrom.

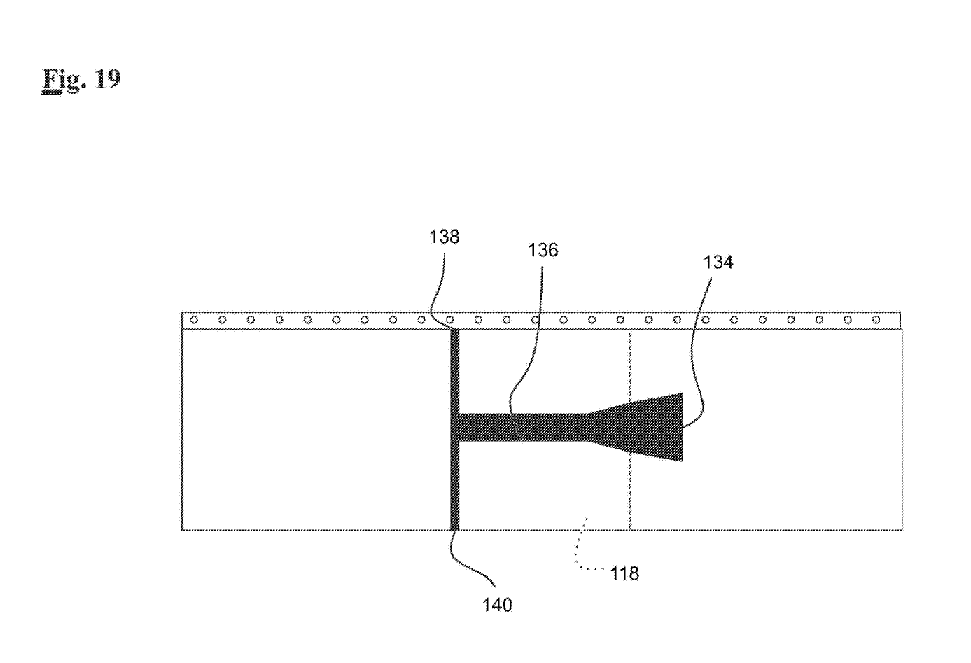

FIG. 19 illustrates the constriction of the restriction improver 128. The free end 134 extends past the inflatable portion 118. A central portion 136 is constricted by the annular ring-shaped ventilation restrictor. The other end 138 is circumferentially fixed to the body 114 around the circumference 140

Returning to FIG. 17, the inflatable portion 118 is located between the first end 122 and the second end 124 of the body 114 providing the length of ventilation ducting. Advantageously both the first end 122 and the second end 124 provide a connector arrangement 142 for joining the body 112 to respective ventilation ducting. Advantageously the airflow restriction device 112 is provided as a standard section of ventilation ducting for mining environments, having an inbuilt ring-type restrictor 120. The ring-type restrictor 120 is of a similar form and construction to the ring-type restrictor 54 previously described. The ring-type restrictor 54 is provided as a tube having two closed ends that are brought together to from a ring.

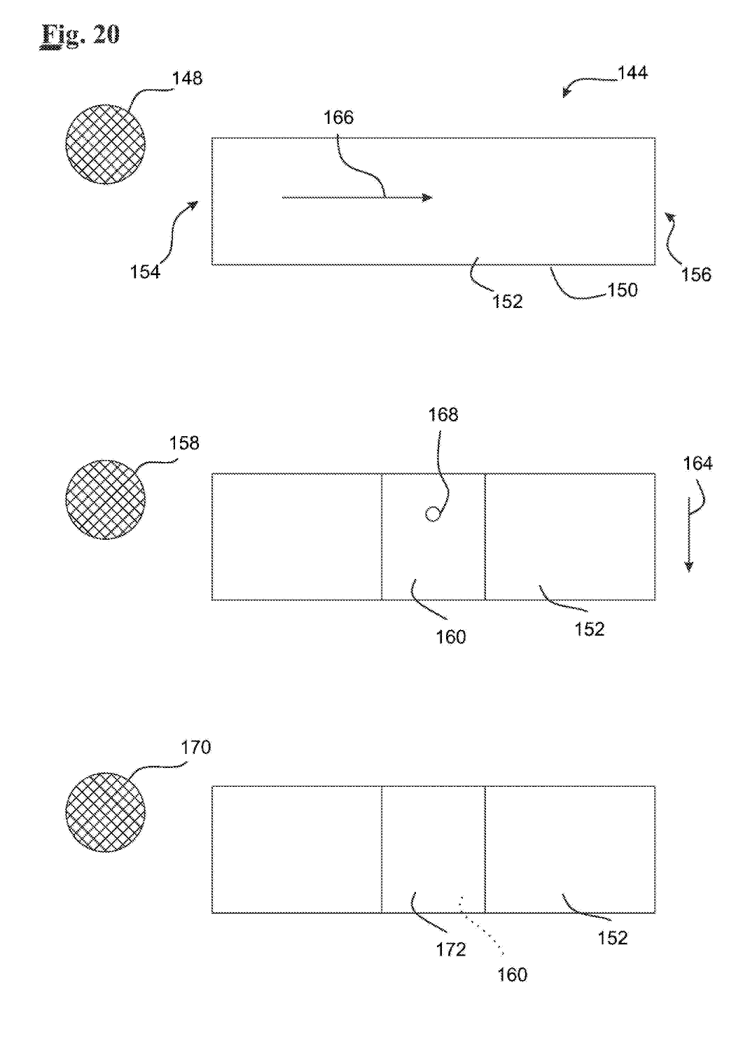

Referring to FIG. 20, there is shown a method 144 of manufacturing an airflow restriction device 146. At block 148, the method 144 includes providing a length 150 of material as a first layer 152; the length having a first end 154 and a second end 156.

At block 158 the method 144 includes positioning a second layer 160 of material 162 across the length in the direction 164 between the first end 154 and the second end 156. The second layer is narrower in the direction 166 of the length the first layer 152, between the first and second ends. An inlet 168 is fitted through the first and second layers.

At block 170, a third layer 172 is positioned on top of the second layer 160.

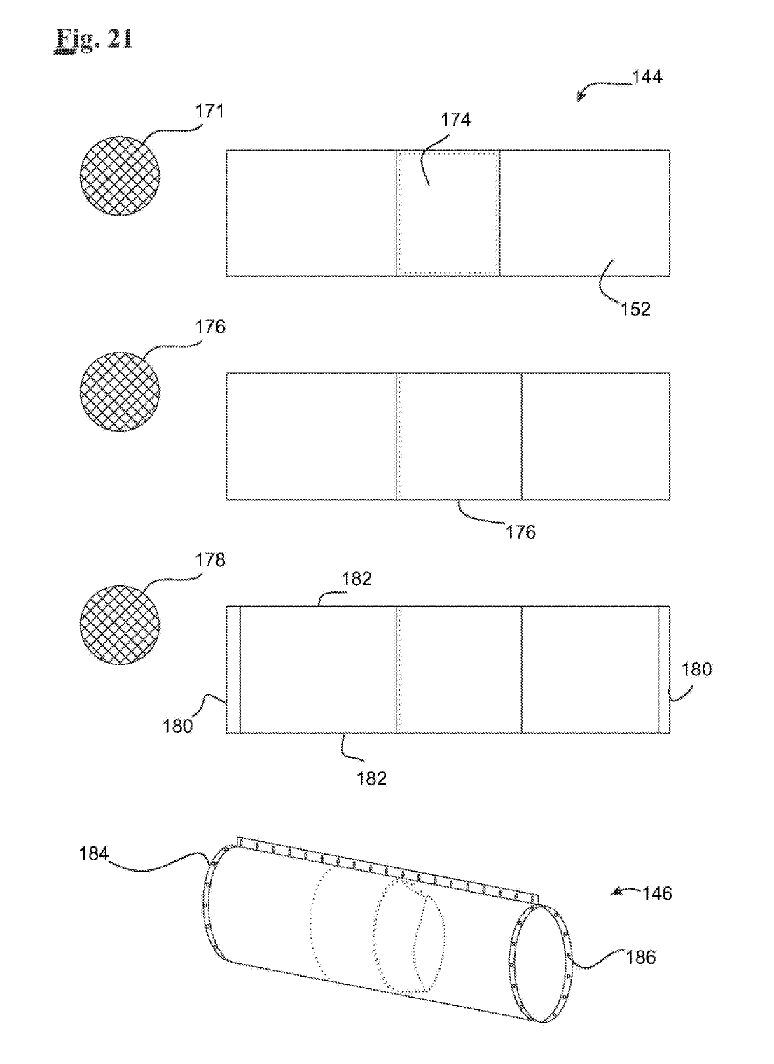

In FIG. 21, at block 171, the second layer 160 and the third layer 172 are heat sealed to form a bladder 174. The bladder is stitched to the first layer 152, in the vicinity of the heat seal.

At block 176, a restriction improver 176 is fixed in place. At block 178, standard connectors 180 are provided in the first end 58 and the second end 156 of the first layer 152. Additionally, the sides 182 extending in the direction of length are joined to form a section of ventilation ducting 146 having a ring type restrictor therein.

A conventional hanging fin is provided after joining the sides 182. As would be apparent various manufacturing processes could be adapted from the described process.

The body of the airflow restriction device 146 includes a first sleeve 184 to allow air to flow into the channel area of the inflatable portion and a second sleeve 186 to allow air to flow out of the channel area of the inflatable portion. Thus there is provided a length of mining ventilation ducting having an inbuilt inflatable portion; the inflatable portion being inflatable to provide a ring-type restrictor that is able to expand inwardly to reduce a central channel area provided by the ring-type restrictor and provide a restriction to air flow.

In various methods a mining ventilation restrictor is provided by layering two sheets across a length of a first sheet; joining the two sheets to the first sheet; and as part of the method forming a ventilation duct with a ring type restrictor therein. In a method of providing the first embodiment of the present invention described the first layer is of the same size as the second layer and the third layer. A connector arrangement is provided as previously described, in relation to the first embodiment, in order to allow the device to be wrapped around a length of ventilation ducting.

In underground mining environments there is generally provided a primary ventilation circuit and a secondary ventilation circuit. The primary vent circuit comprises the main flow of fresh air to the mine, which flows from the portal or entrance to the mine, through the mine to an exhaust circuit or return air way back out to the surface. The secondary ventilation circuit is the vent flow that is taken from the main flow of fresh air (via secondary ventilation fans, hung in the main tunnel) and redirected to the active working headings around the mine via ventilation ducting. The embodiments described are considered to be advantageous when dealing directly with the secondary ventilation circuit.

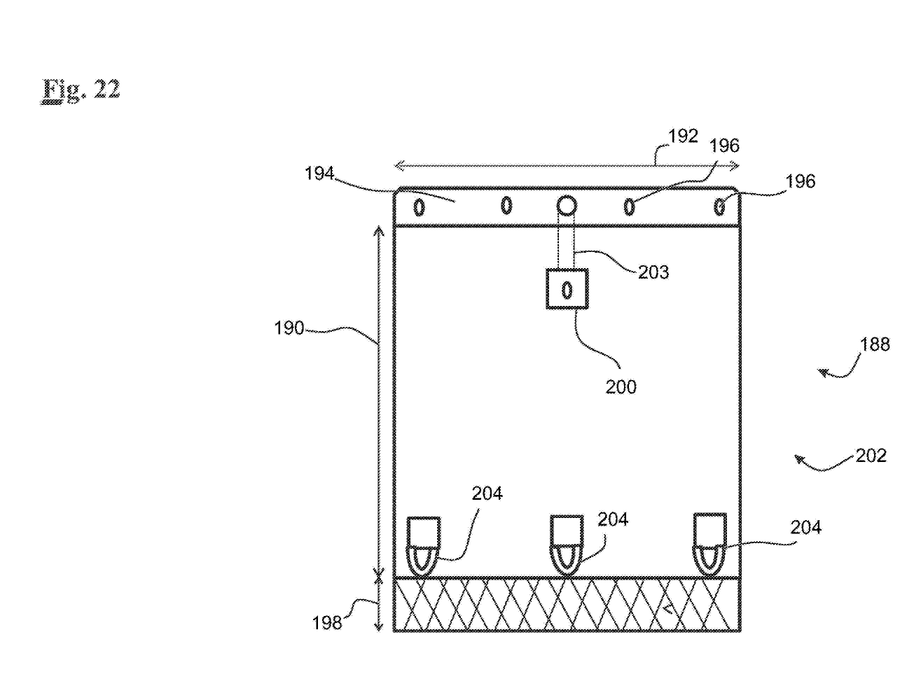

Referring to FIG. 22 there is shown a ventilation choke 188 according to another preferred embodiment of the present invention. The choke 188 is provided as wrap type vent choke for a 1220 mm diameter ventilation bag. The choke 188 is of a rectangular form being approximately 4 m in length. The choke 188 is shown folded in half in FIG. 22.

When folded in half as shown in FIG. 22, a length 190 of about 1.9 m is provided. The choke 188 is about 1 m in width 192. Across the middle of the choke 188 (shown at the top due to choke 188 being folded in half) there is provided a hanging fin 194 having a number of eyelets 196.

Two locking flaps having a length 198 of about 100 mm are provided. The total length of the device is about 4 m. An air inlet 200 is provided to allow the choke to be inflated using compressed air to provide a ring-type restrictor 202. An inlet air line 203 connects the air valve 200 to the hanging fin 194. A number of D-rings 204 are provided adjacent the Velcro tabs.

The choke 188 is considered to provide a wrap type vent choke 188 having a number of advantages. The choke 188 is separable from the ventilation ducting and can easily be moved from one area of a mine to another. The choke 188 can be erected quickly with minimal experience. The choke 188 is considered to be particularly robust. The choke 188 operated using compressed air to inflate or deflate a cylinder type lining. The choke 188 is made of high strength PVC material having good wear resistance properties.

In the embodiment the choke 188 has a small amount of leakage through its design of the seam welded and stitched side panels. This leakage assists in preventing prolonged over inflation of the cylinder lining. The leakage is considered to provide an inbuilt pressure relief. Ideally however there is no leakage allowing the source of compressed air to be disconnected.

The Velcro sealing flaps & securing “D” rings are used during installation. In order to install the system one wraps the vent choke over and around ventilation ducting and firmly presses the two (2) Velcro ends together. As a secure backup there are six (6) securing “D” rings sewn into the end flaps (three (3) on each side). The D rings on each side having positions as shown are held together with the use of small “D” shackle or a quick release carabineer clip. These “D” rings are able to hold an internal inflation pressure over 70 psi (490 kpa) and will not allow the Velcro flaps to pull apart.

Advantageously the choke 188 can be installed with secondary ventilation fans still running. There is no need to stop the flow of fresh-air underground for this device to be fitted.

The choke 188 is extremely light weight, width less than 7 kg. This makes it safe and easy for one person to lift and install. The choke 188 is relatively small and compact, covering an area of 1 metre across. Advantageously the choke 188 can be rolled up and stored into a 300 mm PVC cylinder when not in use.

The flexible PVC panels provide a bladder that this firstly heat seam welded. Following this a third (3rd) panel or outer layer is applied. The edges are then rolled and stitched for further strength. The third panel assists with preferentially providing inward inflation.

The hanging fin 194 and the retaining eyelets are of a standard size and type and can be used with normal size Nokka line (steel Cable) and safety clips that are used on generic vent bags.

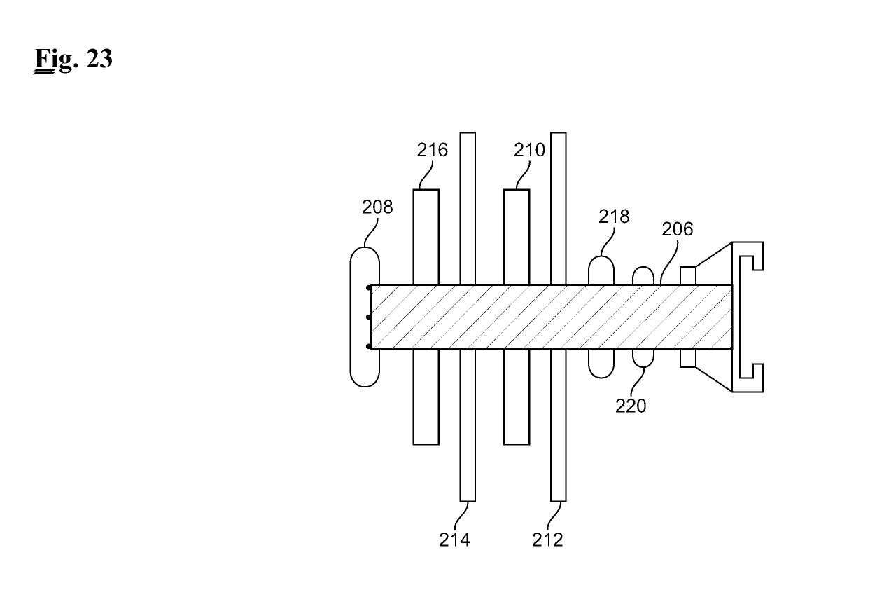

Notably, the inlet 200 is configured to always be open. Referring to FIG. 23 the inlet 200 comprises a hollow pipe section 206 to which is welded a ring 208. A first rubber seal 210 is provided between the outer layer 212 and first layer 214 of the bladder. A second rubber seal 216 is provide between the ring 208 and the first layer 214. Above the outer layer 212 is provided a washer 218 and a locking nut 220. The hollow pipe section 206 is threaded to allow tightening with the use of the locking nut 220.

In this embodiment, the ring 208 and washer 218 each provide a heavy duty washer. The rubber seals 210, 216 provide a 6 mm rubber seal. The layers 212, 214 provide heavy duty PVC lining. A female Minsup fitting and threaded pipe are also provided as shown.

In the embodiment, the inlet provides an air inlet and exhaust valve. The valve is made up of a 20 mm BSP straight male fitting with a thick washer welded at one end this is then passed through a 150 mm×150 mm rubber seal, which also gives the valve mechanical strength. This is placed inside the Vent Choke Bladder a small hole is cut on one side of the second (2nd) panel of PVC, the inlet is fitted through this hole and a second 150 mm×150 mm rubber seal is placed over the valve. The third (3rd) PVC panel or outer support skin is then fitted over the second rubber seal, followed by a washer and nut. This is then torqued up tight. The last fitting to be fitted is a female Minsup fitting used in the underground mining industry.

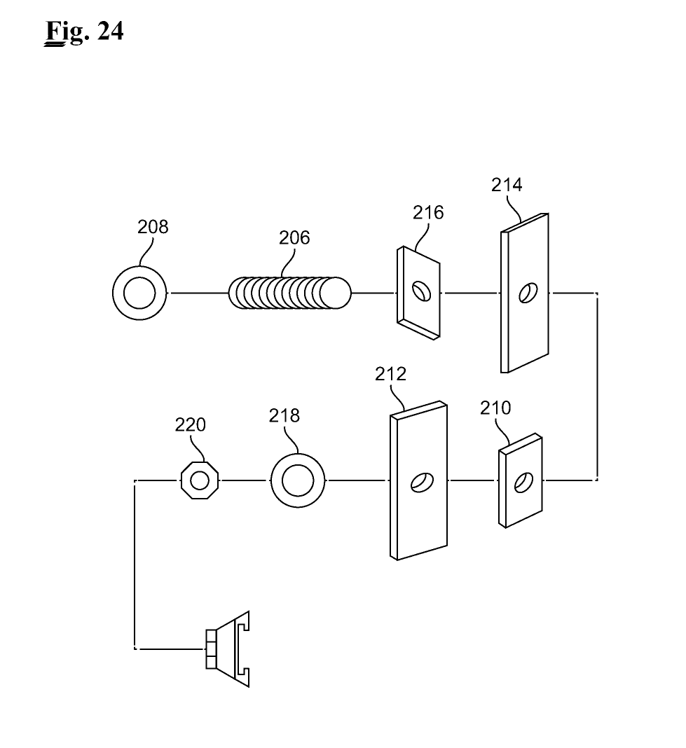

FIG. 24 shows the arrangement of: A—the heavy washer welded on one end of the threaded pipe; B—threaded pipe; C—a 6 mm rubber sealing pad approximately 150 mm by 150 mm; D—an inner lining of PVC bladder; E—a second rubber sealing pad; F—an outer lining of PVC (reinforcement panel); G—a second heavy duty washers (not welded); H—nut locking and I—female Minsup (claw) air fitting. This is used to provide the air inlet and exhaust valve, assembled with vent choke bladder.

The choke 188 utilizes three (3) panels of heavy duty PVC, the material is hard wearing, water proof and does not bypass air through it skin. It is very flexible inflating and deflating without losing its shape.

The system is controlled from the ground, using compressed air via a hose or PVC poly pipe and a 1 inch on/off tap. This feeds air to the two way valve which is always open. The compressed air pressurizes the vent choke one way or releasing pressurised air when the tap is turned off. The wrap choke is wrapped around the existing ventilation ducting wherever the need to divert air flow, reduce or stop air flow completely. In embodiments, chokes come in a range of sizes from 1067 mm to 1400 mm in diameter. Various widths are also provided.

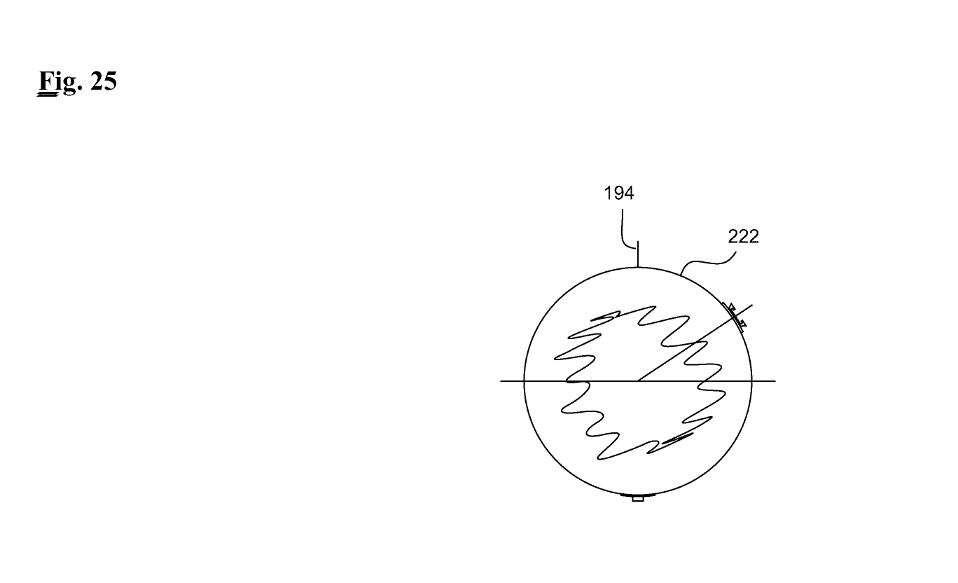

Referring to FIG. 25, the inlet 200 is provided on the upper half 222 of ring type choke 188, when inflated, in the vicinity of the hanging fin 194. The inlet 200 is arranged to be inclined at about 45 degrees away from horizontal as shown in FIG. 25. The sections illustrated show: A—open vent bag flowing fresh air; B—Wrap type vent choke; C—overlap of Velcro flaps and securing D rings; D—inlet and exhaust valve; and E—hanging fin.

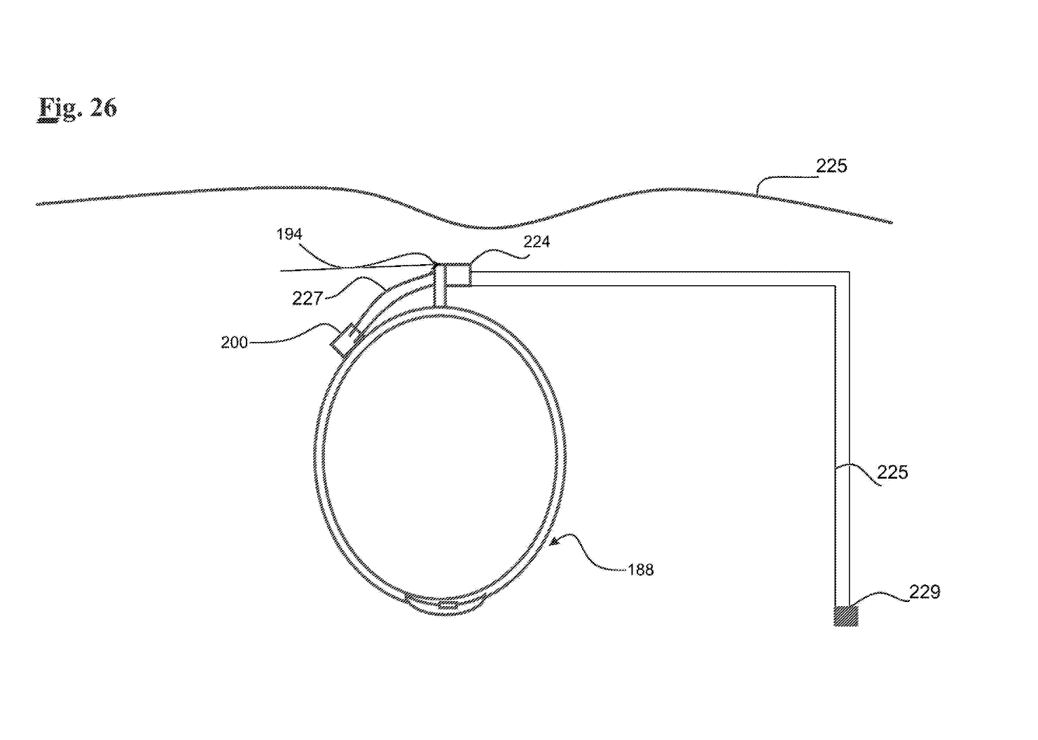

Referring to FIG. 26, an air inlet fitting 224 is mounted on the hanging fin 194 below the roof of a mine drive 225. The inlet air fitting 224 is mounted to the hanging fin 194 to enable a first air line 225 to be attached at to the top of the bag. This allows the air line 225 to be run parallel to the backs (roof) of the heading or drive as shown. This also serves to advantageously take stress off the inlet 200 that extends into the bladder through the outer layer. In this manner an air fitting is fixed to the hanging fin and a conduit extends from the air fitting to an inlet extending into the inflatable potion. The air fitting assists with protecting the inflatable portion from the inlet by limiting situations in which stress/movement will be applied thereto.

A second air line 227 extends from the air inlet fitting 224 on the hanging fin 194 to the inlet air adaptor 200 on the bag. The air inlet fitting 224 connects the second air line 227 to the first air line 225.

More particularly the first air-line 225 extends from the mine drive that feeds compressed air to the fitting 224 attached to the hanging fin 194. The second air-line 227 is fixed from the inlet valve 200 to the inlet fitting 224. The inflation is as simple as opening (turning) a valve or tap to the on position at a location 229, that is accessible by a person from the tunnel floor (without assistance), to allow air flow into the vent bladder. Choosing how far one wishes to choke off the ventilation flow is determined by how much or how little the air valve is opened.

To deflate the vent choke, one must first turn the supply valve off. A second valve or relief valve (tap) is attached by a three way coupling at ground level at location 229. One simply opens this valve or tap fully and the compressed air is forced out of the bladder by the main vent bag now being able to flow fresh air again. The outward force of the secondary ventilation circuit pushes/expands the vent bag against the inside wall of the vent choke.

In various embodiments, it may require 1-2 minutes to fully deflate the vent bladder by the action of the vent bag.

A high percentage of underground mines carry hoses and hose connections, taps and three way couplings and provide a supply of compressed air at locations accessible by a person (without assistance—eg ladder) on the floor level.

Thus there is provided an on/off valve or tap at ground level, an external compressed air line or hose running parallel to the backs of the mine drive, a hanging fin, a fixed air-line extending from the inlet on the handing fin to a valve on the vent choke, velcro locking flap with securing d rings; with the vent choke wrapped around the vent bag.

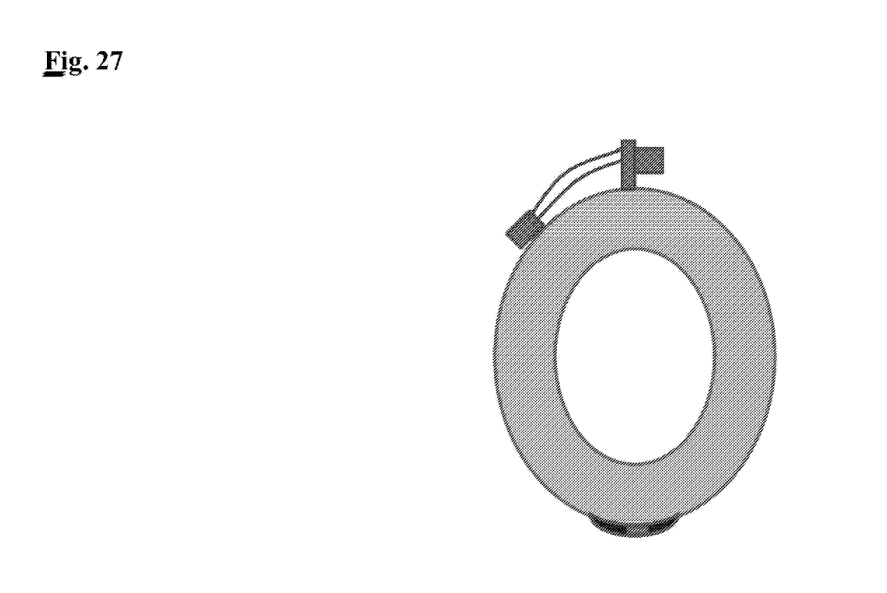

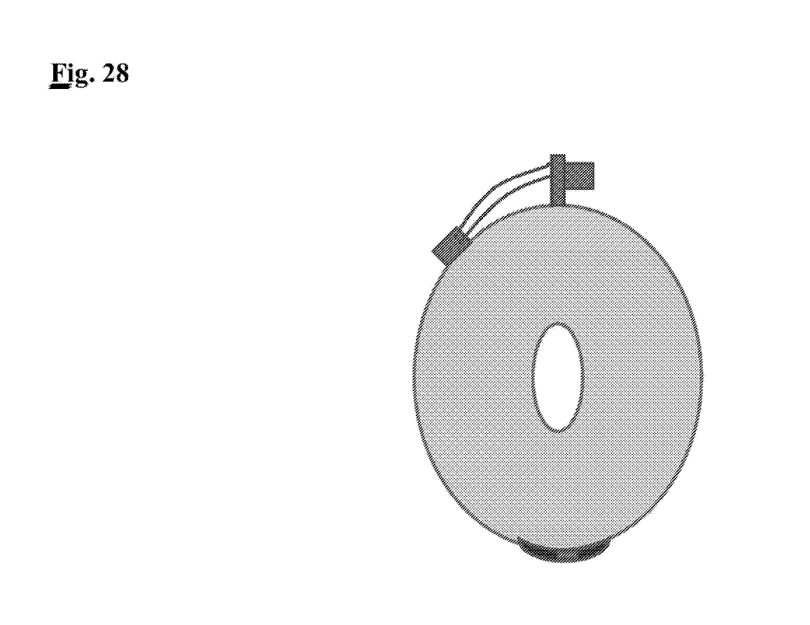

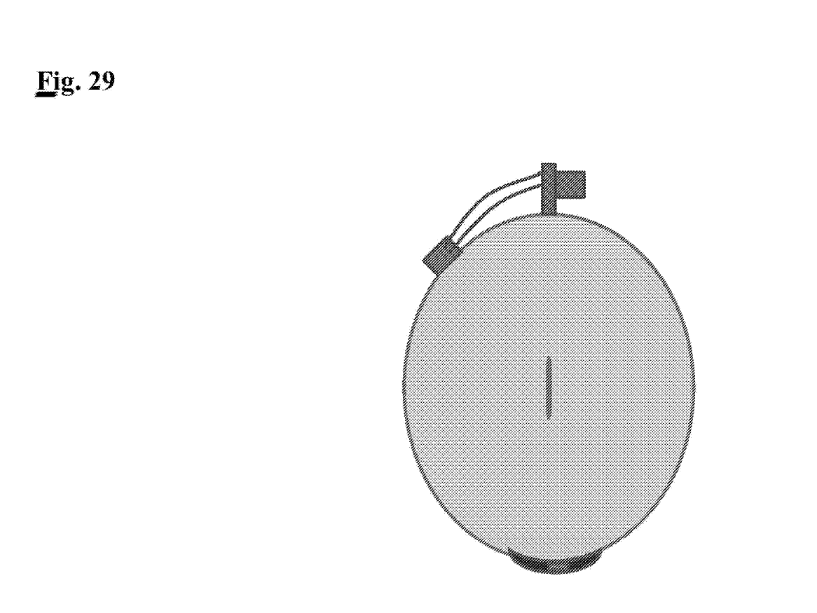

FIGS. 27 to 29 illustrate the operation of the choke 188. In FIG. 27, the vent choke is wrapped around the vent bag, air starts to fill the vent bladder to starts to choke off the vent bag. The Velcro locking flap and securing D rings maintain the choke. Minsup 1″ compressed air inlet fitting hose and valve assembly is used to receive the compressed air. In FIG. 28, the vent bag is 75% choked with very little air moving through the centre. In FIG. 29, the vent bag is substantially 100% choked with very little air moving through the centre.

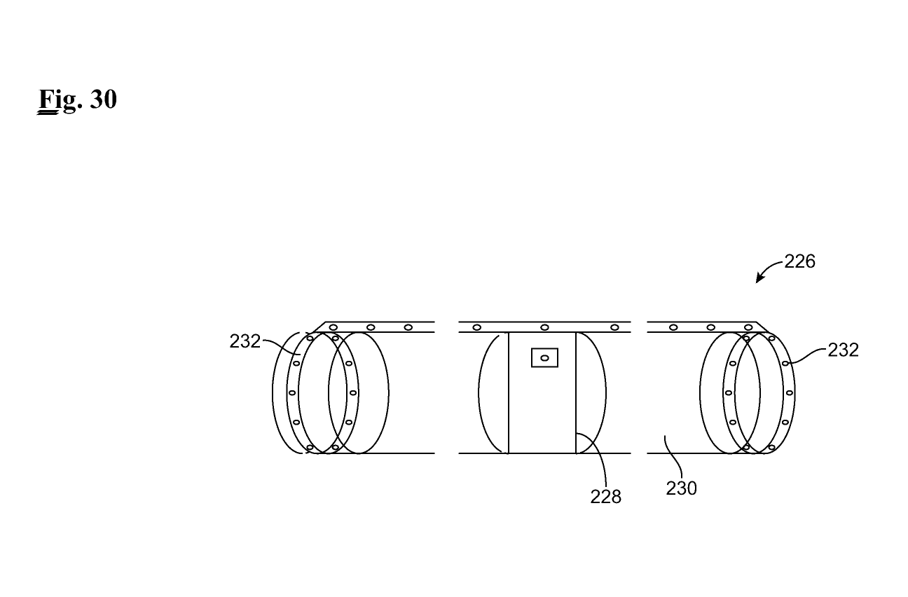

FIGS. 30 and 31 illustrate an inline choke 226 according to a further preferred embodiment of the present invention. The inline choke 226 is 5 metres in length and made up of 3 sections of normal polyethylene woven fabric. In the embodiment there is provided a 1 metre section of PVC (bladder) 228; and a second 5 m section of poly ethylene woven fabric 230.

The PVC bladder is centrally positioned and is about 1.2 m in length. Sealing joints 232 have connection eyelets are provided at either end.

This 5 metre inline vent choke is added to the normal ventilation system wherever it is required to reduce, divert or stop ventilation flow. As with the wrap-type vent-choke 196, both systems rely on the use of compressed air inflating a bladder or sealed tube to apply inward force on the ventilation ducting (wrap type) or to seal the flow of air (inline type) to redirect ventilation flow to another area of ducting.

The inline type vent choke can be reused and moved to other locations around the mine. The inline type vent choke comes in a nominal 5 metre length this supports the most common lengths of Vent Duct used in Underground Hard Rock Mining which is 5, 10, 15, 20 and 50 metre lengths. This provides the flexibility to add and install just about anywhere in the mine. The vent choke can be erected quickly with minimal experience needed. The device works on compressed air to inflate or deflate a cylinder type lining. The choke is made of high strength PVC material which has good wear resistant properties. The choke has a small amount of leakage through its design of the seam welded and stitched side panels. This leakage assists in the prolonged over inflation of the cylinder lining and is basically an inbuilt pressure relief. The stitching is offset from the heat sealing to allow for leakage through the stitching.

Advantageously, the inline vent choke is similar to the wrap type vent choke but it is designed with a fully encapsulated vent bladder. This bladder is fully seam welded and stitched on its outer edges of PVC Polymer. It incorporates two (2) polyethylene woven fabric sleeves at each end of the PVC bladder for attachment and a third polyethylene sleeve stitched to the inner circumference area of the PVC bladder. The third sleeve assists when near 100% total sealing of ventilation is required (or choking off). This system also comes with two (2) extra sealing joints, one at each end of the Vent Choke to assist in ventilation sealing when joining up to the other Vent Bags.

The device is extremely light weight, weighing under 9 kg. This makes it safe and easy for one person to lift and install.

Both PVC panels of the device are firstly heat seam welded and then the third (3rd) panel or outer layer is applied. The edges are then rolled and stitched for further strength. The hanging fin, sealing joint and retaining eyelets are of a standard size and type and can be used with normal size nokka line (steel Cable) and safety clips that are used on generic vent bags.

The inlet valve is simple and is always open. Made up of a 20 mm BSP straight male fitting with a thick washer welded at one end this is then passed through a 150 mm×150 mm rubber seal, which also gives the valve mechanical strength. This is placed inside the Vent Choke Bladder a small hole is cut on one side of the second (2nd) panel of PVC, the inlet valve is fitted through this hole and a second 150 mm×150 mm rubber seal is placed over the valve. The third (3rd) PVC panel or outer support skin is then fitted over the second rubber seal, followed by a washer and nut. This is then torqued up tight. The last fitting to be fitted is a Female Minsup fitting used in the Underground Mining Industry.

The Inline type vent choke utilizes three (3) panels of heavy duty PVC, this material is hard wearing, water proof and does not bypass air through it skin. It is very flexible inflating and deflating without losing its shape. The Inline Vent Choke has two (2) sections of polyethylene one at each end to be compatible when joining up with other vent bags. Embodiment can be provided in a range of sizes include sizes from 1000 mm to 1400 mm in diameter. Various lengths can also be provided.

The system is controlled from the ground, using compressed air via a hose or PVC poly pipe and a 1 inch on/off tap. This feeds air to the two way valve which is always open pressurising the vent choke one way or releasing pressurised air when the tap is turned off.

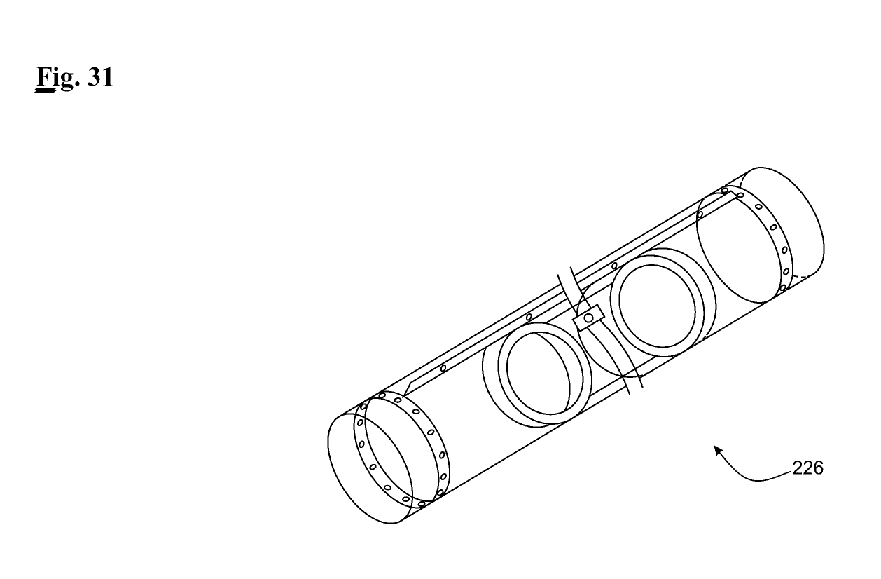

In a further embodiment illustrated in FIG. 32, there is provided an airflow restriction device 300 according to a further preferred embodiment of the present invention. The airflow restriction device 300 is provided in the form of a wrap type vent choke 304. All the joins that are around both ends/sides of the vent choke are fully seam welded rather than being stitched and welded. All stitched areas are covered with a strip of PVC material and are seam weld this to prevent air loss. In other embodiments all the joins could seam welded without there being any stitching at all.

The vent choke 304 comprises a wrap type vent choke for being wrapped around a 1400 vent bag (not shown). The vent choke 304 includes a first end 308 for being secured to the vent bag (not shown) to prevent movement of the vent choke along the vent bag (not shown). The first end comprises an end having a ring of spaced eyelets 310. The vent chock 304 has a double zipper system 306 rather than a Velcro™ fixing system.

In the embodiment shown the eyelets 310 on the first end 308 are spaced at about 140 mm along the end. The material comprises 900 gram ‘rip-stop’ woven material. In distinction from the other wrap type embodiments described the first end 308 provides an additional securing end that is fixed the ventilation ducting passing through the choke 304.

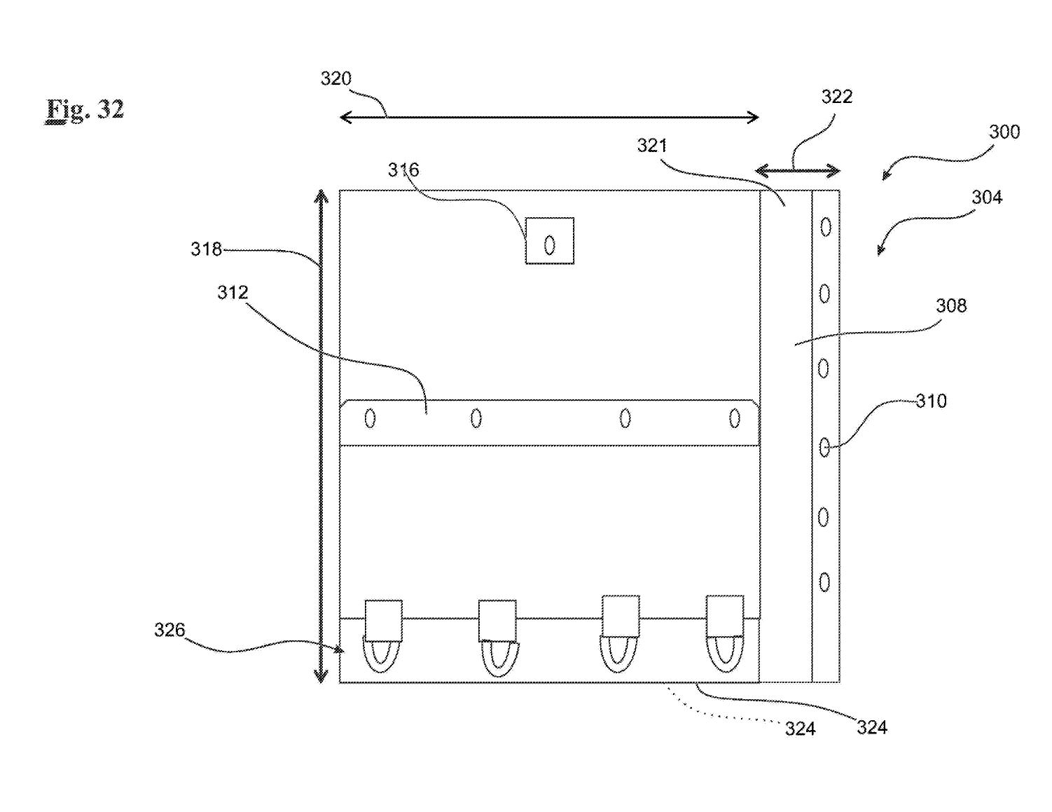

The vent choke 304 is shown folded in half. As highlighted in FIG. 33 a hanging fin 312 is provided at a non-central position. The hanging fin 312 is positioned about 1 quarter of the full extended length from a joining end 314. That is, about 1 quarter of the full extended length from an end that is joined to an opposite end to form the annular structure. This ensures that the joining ends are positioned about ¼ of a turn from the hanging fin 312 when the ends are joined to provide the restricting annular form around ventilation ducting.

The valve inlet 316 is spaced to be disposed about ¼ of a turn away from the hanging fin 312 and the joining ends 314. In this embodiment is positioned to be about 900 mm away from the hanging fin. This distance becomes the circumferential distance when wrapped around the ventilation ducting.

The half length 318 is about 2.2 meters and the width 320 is about 1200 mm plus say a 50 mm allowance. A flap 321 that is joined to the expandable bladder provides the first end 318. The flap provides an additional width portion 322 of 300 mm. For a 1220 mm vent bag the half-length is about 1.9 m. For a 1067 mm vent bag the half length in about 1.68 meters.

Referring to FIG. 33, the choke 304 includes two heavy duty zippers 324 (and securing D rings 326 (See FIG. 32). The zippers open and close in opposite directions. This is considered to provide a further degree of security against expansion and opening of the zippers. An additional protective layer 328 is provided to protect the lower portion of 330 of the choke 304 when in the annular form. The protective layer is disposed in a lower position to protect the lower portion of the choke 304.

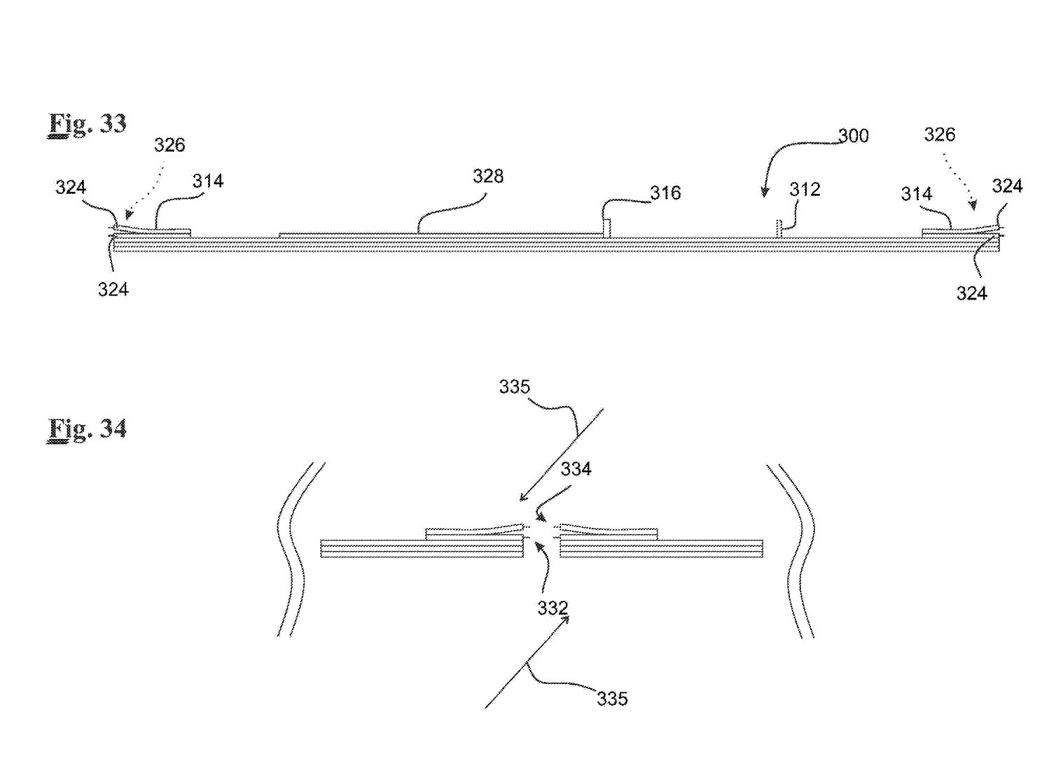

As highlighted in FIG. 34, the double zipper arrangement includes a first zipper 332 provided at an inner location. The first zipper 332 seals the bladder. A second zipper 334 is provided at a relatively outer location. The zippers 332 and 334 open in opposite directions 335, one from the left and one from the right. This may assist with uncontrolled or unintended opening of the two zippers.

Thus there is provided a vent choke 300 having a sleeve on one side which has eyelets around the perimeter to be attached over an existing vent bag join. Notably this has been done to prevent walking or moving of the vent choke when it is inflated with there being very high pressures or forces acting on the device from the incoming ventilation being choked or stopped. Otherwise, it has been seen that the vent choke would have a tendency to move along its steel cable upon which the vent choke and vent bag are suspended.

A high strength/grade material is provided on the underside portion of both the wrap and inline type vent chokes. This is considered to assist with longevity. This should make the vent choke more wear resistant against trucks or machinery that may come into contact or rub against the bottom of the vent chokes. In some embodiments there will be four (4) layers of material on the underside base portion with the upper portion having 3 layers of material.

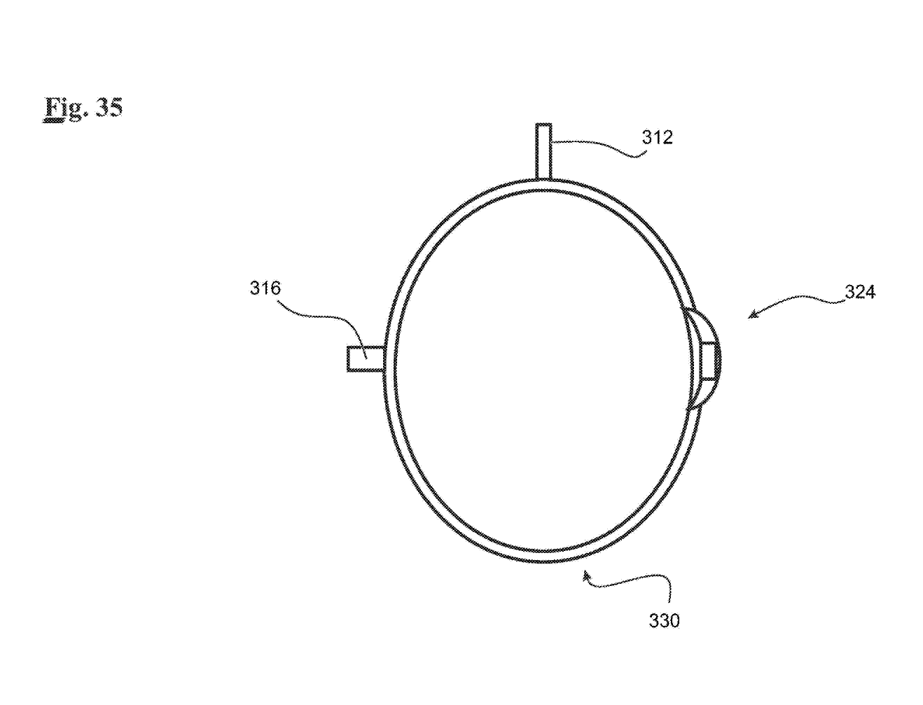

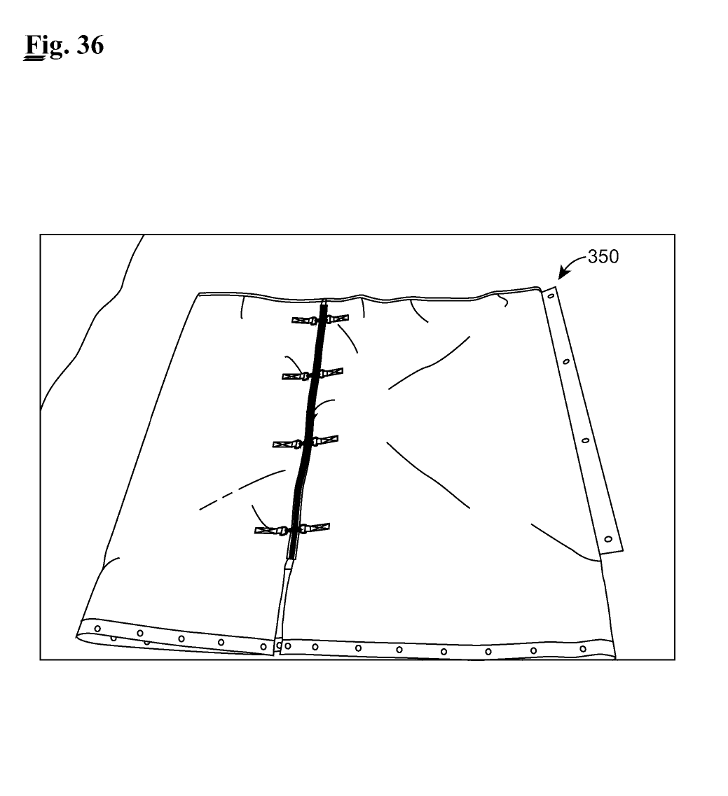

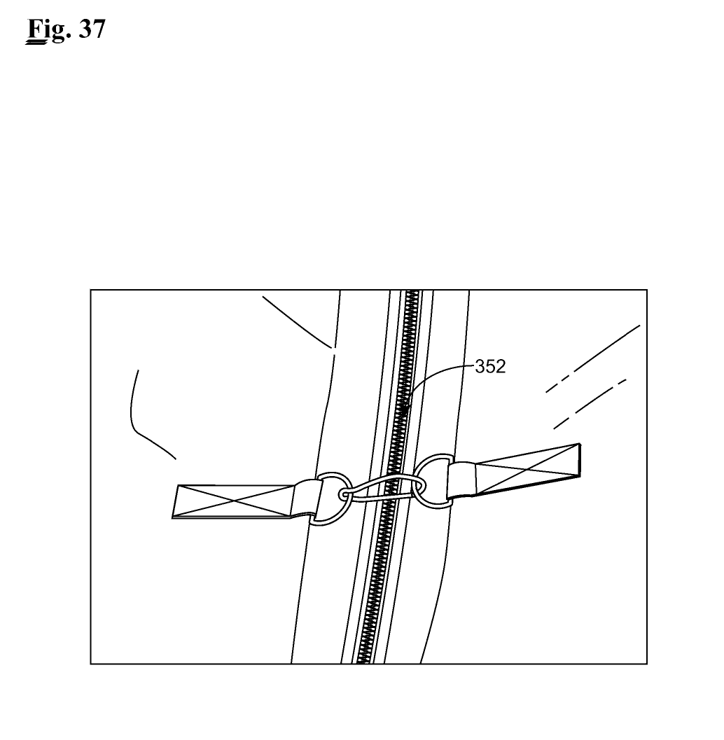

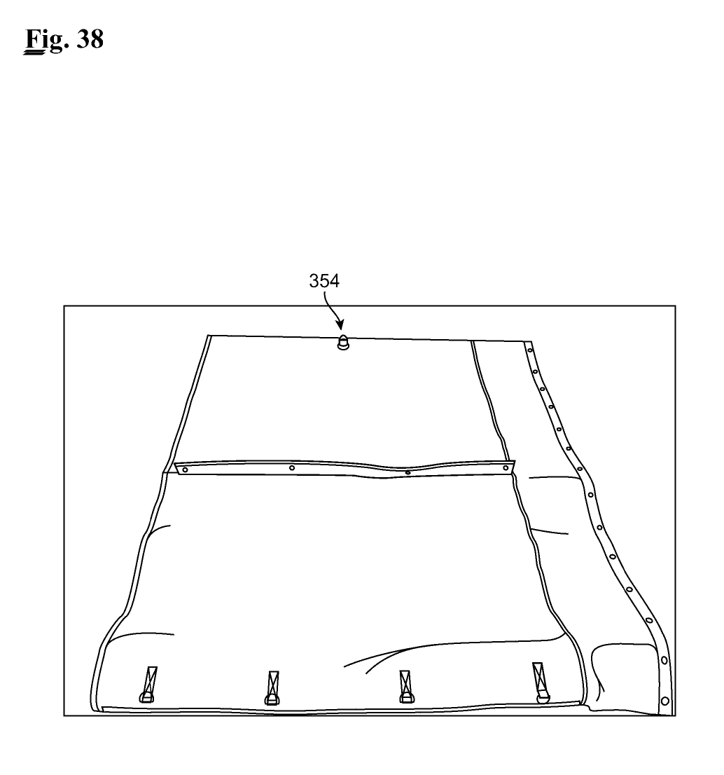

FIGS. 36 to 38 provides an illustration of a restriction device 350 having the features of a further embodiment. An outside zipper 352 is shown. The inner zipper is hidden from view. In addition there is provided a condensation drain 354. As gas expands it cools, which could generate condensation within the vent choke. It is considered advantage to provide a drain point at the base of the underside of the vent chokes. FIG. 35 illustrates the positioning of the hanging fin 312, the valve inlet 316 and the zippers 324

In some embodiments a valve is fitted at one end of the underside to drain any water that maybe trapped inside the vent chokes annular ring tube. The valve will operate to seal the opening when there is pressure applied from inside the bladder. When the vent choke is deflated it will be able to self-drain. A condensation drain could also be provided with some unsealed stitching that allows for somedrainage whilst leaking some air.

In this regard it is noted that ideally it possible to inflate a vent choke with there being substantially little to no air losses through its design. This should save on wasted compressed air having to continuously be pumped into the device to keep it choked off.

The embodiments described are considered to be particularly useful when men or machinery are working in one area of a mine and not the other. The operator can simply turn a valve on from the ground using a source of compressed air and stop the flow of ventilation air through the ventilation ducting. The operator is able redirect the ventilation air to another path or heading.

Applications could include: (i) when ventilation has to be upgraded or replaced in a certain drive or area; (ii) when underground firing is to take place in certain drives or levels ventilation can be shut off in non-active headings and the air flow redirected to the headings being fired to clear the toxic fumes quicker; (iii) any work that has to be done on the backs (roof) that typically the ventilation hinders the process or gets in the way (electricians hanging electrical cabling, poly services being moved across the backs.); (iv) area's where ventilation is very poor because of too many active headings are being run off the same secondary ventilation fan; (v) where the distances from secondary vent fans are getting greater.

Advantages of the inline and wrap chokes include: (i) being very quick to install; (ii) providing a 2 person job to install out of an IT and basket (one operating machine one installing vent choke); (iii) being readily removed and reinstalled in another part of the mine.

The benefits to mining companies may include the provision of: (i) a cost effective way of redirecting air flow to where it is needed around the mine; (ii) reducing re-entry times by diverting maximum amount of available secondary ventilation to areas of the mine that have been fired; (ii) limiting expensive repairs and re work to vent system, due to choke rope system not working properly; (iii) prolonging the need to introduce more secondary ventilation fans into the mine; and (iv) health and safety.

Mining personal are able to: (i) redirect unused ventilation to other work area's; (ii) supply more ventilation to work areas where there is a high machinery; (iii) supply better ventilation, especially in mines where the wet season can affect underground ventilation dramatically.

As would be apparent, various alterations and equivalent forms may be provided without departing from the spirit and scope of the present invention. This includes modifications within the scope of the appended claims along with all modifications, alternative constructions and equivalents.

There is no intention to limit the present invention to the specific embodiments shown in the drawings. The present invention is to be construed beneficially to the applicant and the invention given its full scope.

In the present specification, the presence of particular features does not preclude the existence of further features. The words ‘comprising’, ‘including’ and ‘having’ are to be construed in an inclusive rather than an exclusive sense.

It is to be recognised that any discussion in the present specification is intended to explain the context of the present invention. It is not to be taken as an admission that the material discussed formed part of the prior art base or relevant general knowledge in any particular country or region.

1-60. (canceled)

61. An airflow restriction device comprising: a body having an inflatable portion;
the inflatable portion being able to be positioned around a length of flexible ventilation ducting; the inflatable portion being inflatable to provide a ring-type restrictor that is able to expand inwardly to reduce the cross-section of an inner channel area provided by the ring type restrictor, through which the ventilation ducting extends, to constrict the ventilation ducting.

62. The airflow restriction device according to claim 61, wherein the body includes a first end, a second end, and a connection arrangement; the connection arrangement for use in selectively connecting the first end and the second end together to form the ring-type restrictor when the inflatable portion is positioned around the length of flexible ventilation ducting.

63. The airflow restriction device according to claim 62, wherein the connection arrangement includes a flap provided on the first end or the second end of the body, the flap for providing an first connection between the first end and the second end, before a second connection is provided between the first end and the second end.

64. The airflow restriction device according to claim 62, wherein connection arrangement includes a first zipper and a second zipper for providing a releasable connection between the first end and the second end; the first zipper concealing the second zipper when in a zipped condition.

65. The airflow restriction device according to claim 62, wherein the connection arrangement includes anchor elements positioned on the first end and on the second end; the anchor elements for use in securing the first end and the second end together; and the anchor elements comprising a number of spaced apart loop anchors allowing connectors to secure the first end and the second end together.

66. The airflow restriction device according to claim 61, wherein the inflatable portion includes a first layer group and a second layer group; the inflatable portion being able to be inflated with air, with the air being accommodated in a region between the first layer group and the second layer group; the first layer group being relatively non-stretchable; and the second layer group being relatively stretchable, the first and the second layer groups serving to assist the ring-type restrictor to expand inwardly to reduce the inner channel area and provide the restriction to air flow.

67. The airflow restriction device according to claim 66, wherein the first layer group comprises a first layer and a second layer, the first layer being relatively non-stretchable and the second layer being relatively stretchable; the first layer serving to make the first layer group relatively non-stretchable, and the second layer providing a relatively air impermeable layer in comparison to the first layer.

68. The airflow restriction device according to claim 67, wherein the second layer group comprises a relatively stretchable layer, the relatively stretchable layer being relatively air impermeable.

69. The air flow restriction device according to claim 61, including a drain for condensation, the drain providing a seal when there is sufficient pressure applied to the drain, and otherwise providing an open drainage outlet through which water is able to pass.

70. The airflow restriction device according to claim 61, wherein the inflatable portion has a width of at least 0.8 m, the width extending along the ventilation ducting, when the inflatable portion is positioned around the ventilation ducting.

71. An airflow restriction device comprising:
a body providing a length of ventilation ducting; and
an inflatable portion, the inflatable portion being inflatable to provide a ring-type restrictor that is able to expand inwardly to reduce the cross-section of an inner channel area provided by the ring type restrictor and provide a restriction to air flow.

72. The airflow restriction device according to claim 71, including a restriction improver that is positioned to be constricted by the inflatable portion, when the inflatable portion is inflated, to restrict air flow through the restriction improver.

73. The airflow restriction device according to claim 72, wherein the restriction improver is positioned to lie within a passage provide by the inflatable portion.

74. The airflow restriction device according to claim 73, wherein the restriction improver comprises a sock-type element fixed to the body at a first position and having a free end spaced therefrom.

75. A method of manufacturing an airflow restriction device comprising providing a body having inflatable portion that is inflatable to provide a ring-type restrictor that expands inwardly to reduce an inner channel area and provide a restriction to air flow; the method including providing the body with a first sleeve to allow air to flow into the channel area of the inflatable portion; and a second sleeve to allow air to flow out of the channel area of the inflatable portion.

76. The method according to claim 75, further including providing the first sleeve and the second sleeve with a connector arrangement to connect to respective ventilation ducting.

77. A method of manufacturing an airflow restriction device, the method comprising:
forming a body by fixing together a number of layers of material to provide an inflatable portion having an inflatable chamber between a first layer group and a second layer group; the first layer group being relatively non-stretchable; and the second layer group being relatively stretchable; and
providing the first layer group with a connector allowing the inflatable portion to provide an inflatable ring type restrictor; the first and second layer groups serving to assist with the ring-type restrictor being able to expand inwardly to reduce an inner channel area and provide a restriction to air flow.

78. The method according to claim 77, including fixing a flap to a first end of the outer surface of the first layer group, to allow the body to be positioned around a length of flexible ventilation ducting and to be joined with the assistance of the flap.

79. The method according to claim 78, including fixing a flap to a second end of the outer surface of the first layer group, to allow the body to be positioned around a length of flexible ventilation ducting and to be joined with the assistance of the flap.

80. The method according to claim 77, including fixing a hanging connector to the first layer group, the hanging connector for use in supporting the body above the ground.

81. An airflow restriction device comprising: a body having an inflatable portion;
the inflatable portion being inflatable to provide a ring-type restrictor that is able to expand inwardly to reduce the inner channel area provided by the ring type restrictor and provide a restriction to air flow.
